(19) United States
(12) Patent Application Publication
(10) Pub. No.: US 2026/0361370 A1
(43) Pub. Date: Nov. 12, 2026

(54) TECHNIQUES FOR BEAM MANAGEMENT

(71) Applicant: QUALCOMM Incorporated, San Diego, CA (US)

(72) Inventors: Qiaoyu LI, Beijing (CN); Taesang YOO, San Diego, CA (US); Mahmoud TAHERZADEH BOROUJENI, San Diego, CA (US); Tao LUO, San Diego, CA (US); Hamed PEZESHKI, San Diego, CA (US); Tianyang BAI, Somerville, NJ (US); Arumugam CHENDAMARAI KANNAN, San Diego, CA (US)

(21) Appl. No.: 19/129,615

(22) PCT Filed: Dec. 15, 2022
(86) PCT No.: PCT/CN2022/139259

§ 371 Date: May 13, 2025

(51) Int. Cl. H04B 7/06

(52) U.S. Cl. CPC H04B 7/0658; H04B 7/063; H04B 7/0695

(57) ABSTRACT

Methods, systems, and devices for wireless communications are described. A user equipment (UE) may predict, for each of a set of beams, a sequence of values for at least one parameter. The UE may perform respective encoding operations on at least a subset of the set of beams, where a quantity of bits of the encoded sequences of predicted values generated by performing the respective encoding operations is based on an uncertainty value for the sequences of predicted values. The UE may transmit, to a network entity, a message including the bits of the encoded sequences of predicted values. The network entity may transmit multiple reference signals using the set of beams. The network entity may receive the message including the bits and perform one or more decoding operations on the set of bits based on the uncertainty value.

### CROSS REFERENCE

The present Application is a 371 national stage filing of International PCT Application No. PCT/CN2022/139259 by LI et al. entitled “TECHNIQUES FOR BEAM MANAGEMENT,” filed Dec. 15, 2022, which is assigned to the assignee hereof, and which is expressly incorporated by reference in its entirety herein.

### FIELD OF TECHNOLOGY

The following relates to wireless communications, including techniques for beam management.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities (e.g., base stations), each supporting wireless communication for communication devices, which may be known as user equipment (UE).

Some communication devices (e.g., network entities and UEs) may be capable of performing directional communications. For example, a communication device may include multiple antenna ports, which may transmit communications directionally by selectively creating constructive interference such that a signal may be amplified in a specific direction. In some cases, communication devices that communicate directionally (e.g., using beamforming techniques) may perform beam management operations to select one or more beams for communications. For the purposes of beam selection, a communication device may determine (e.g., measure, calculate, predict) parameters for multiple beams and compare the parameters to determine a beam (e.g., a preferred beam). For example, a UE may utilize a mathematical model to predict reference signal receive powers (RSRPs) for multiple beams (e.g., multiple hypothetical beams, multiple beam candidates). The UE may then compare the predicted RSRPs to determine a beam for communications with a network entity.

### SUMMARY

The described techniques relate to improved methods, systems, devices, and apparatuses that support techniques for beam management. For example, the described techniques provide for a communication device (e.g., a user equipment (UE), a network entity) to improve utilization of communication resources and effectiveness of beam management operations by communicating uncertainty information and information for beam parameters using variable bit-width signaling, such that information with a relatively low uncertainty value is communicated using fewer bits than information with a relatively high uncertainty value. In such cases, a communication device may predict a sequence of values for one or more parameters (e.g., reference signal received powers (RSRPs), signal-to-interference-plus-noise rations (SINRs)) and may perform respective encoding operations on the predicted sequences of values. The respective encoding operations may output a quantity of bits based at least in part on an uncertainty value (e.g., a total uncertainty value, an overall uncertainty value) for the sequences of predicted values. The communication device may then transmit a message to another communication device including the bits (e.g., the bits of the encoded sequences of predicted values). Accordingly, the communication device may select one or more beams (e.g., beam-pairs) for communications based on the uncertainty value for the sequences of predicted values.

A method for wireless communication at a UE is described. The method may include predicting, for each of a set of multiple beams, a sequence of values for at least one parameter, performing respective encoding operations on at least a subset of the sequences of predicted values for the at least one parameter for at least a subset of the set of multiple beams, where a quantity of bits of the encoded sequences of predicted values generated by performing the respective encoding operations is based on an uncertainty value for the sequences of predicted values, and transmitting, to a network entity, a message including the bits of the encoded sequences of predicted values.

An apparatus for wireless communication at a UE is described. The apparatus may include a processor, memory coupled with the processor, and instructions stored in the memory. The instructions may be executable by the processor to cause the apparatus to predict, for each of a set of multiple beams, a sequence of values for at least one parameter, perform respective encoding operations on at least a subset of the sequences of predicted values for the at least one parameter for at least a subset of the set of multiple beams, where a quantity of bits of the encoded sequences of predicted values generated by performing the respective encoding operations is based on an uncertainty value for the sequences of predicted values, and transmit, to a network entity, a message including the bits of the encoded sequences of predicted values.

Another apparatus for wireless communication at a UE is described. The apparatus may include means for predicting, for each of a set of multiple beams, a sequence of values for at least one parameter, means for performing respective encoding operations on at least a subset of the sequences of predicted values for the at least one parameter for at least a subset of the set of multiple beams, where a quantity of bits of the encoded sequences of predicted values generated by performing the respective encoding operations is based on an uncertainty value for the sequences of predicted values, and means for transmitting, to a network entity, a message including the bits of the encoded sequences of predicted values.

A non-transitory computer-readable medium storing code for wireless communication at a UE is described. The code may include instructions executable by a processor to predict, for each of a set of multiple beams, a sequence of values for at least one parameter, perform respective encoding operations on at least a subset of the sequences of predicted values for the at least one parameter for at least a subset of the set of multiple beams, where a quantity of bits of the encoded sequences of predicted values generated by performing the respective encoding operations is based on an uncertainty value for the sequences of predicted values, and transmit, to a network entity, a message including the bits of the encoded sequences of predicted values.

Some examples of the method, apparatuses, and non-transitory computer-readable medium described herein may further include operations, features, means, or instructions for receiving a request from the network entity to transmit the message based on a ranking of the sequences of predicted values, where the UE determines the uncertainty value for the at least the subset of the sequences of predicted values based on a function of respective variance values of the at least the subset of the sequences of predicted values.

Some examples of the method, apparatuses, and non-transitory computer-readable medium described herein may further include operations, features, means, or instructions for receiving a request from the network entity to transmit the message based on a ranking of the sequences of predicted values, where the UE determines the uncertainty value for the at least the subset of the sequences of predicted values based on a variance value of a sequence of predicted values of the subset of the sequences of predicted values, the sequence of predicted values selected from the subset of the sequences of predicted values based on respective signal powers associated with the subset of the sequences of predicted values.

In some examples of the method, apparatuses, and non-transitory computer-readable medium described herein, transmitting the message to the network entity may include operations, features, means, or instructions for transmitting the message including the bits of the at least the subset of encoded sequences of predicted values, where the bits correspond to a quantity of the at least the subset of the sequences of predicted values having respective rankings that satisfy a threshold.

Some examples of the method, apparatuses, and non-transitory computer-readable medium described herein may further include operations, features, means, or instructions for receiving, from the network entity, an indication of a configuration for determining the uncertainty value for the at least the subset of the sequences of predicted values, where the UE determines the uncertainty value based on the configuration.

Some examples of the method, apparatuses, and non-transitory computer-readable medium described herein may further include operations, features, means, or instructions for determining the uncertainty value for the at least the subset of the sequences of predicted values and transmitting, to the network entity, an indication of a configuration for determining the uncertainty value.

In some examples of the method, apparatuses, and non-transitory computer-readable medium described herein, the configuration for determining the uncertainty value corresponds to a mathematical model of a set of multiple mathematical models for predicting the sequence of values for the at least one parameter.

Some examples of the method, apparatuses, and non-transitory computer-readable medium described herein may further include operations, features, means, or instructions for receiving, from the network entity, an indication of a configuration for determining the quantity of bits based on the uncertainty value, the configuration indicating a mapping between one or more ranges of uncertainty values and respective quantities of bits.

In some examples of the method, apparatuses, and non-transitory computer-readable medium described herein, receiving the indication of the configuration may include operations, features, means, or instructions for receiving, from the network entity, a channel state information report configuration including the indication, a medium access control control element that activates a channel state information report including the indication, or downlink control information that activates the channel state information report including the indication where the channel state information report includes the bits of the encoded sequences of predicted values.

Some examples of the method, apparatuses, and non-transitory computer-readable medium described herein may further include operations, features, means, or instructions for transmitting, to the network entity, an indication of the quantity of bits of the at least the subset of encoded sequences of predicted values.

Some examples of the method, apparatuses, and non-transitory computer-readable medium described herein may further include operations, features, means, or instructions for transmitting the indication of the quantity of bits corresponds to a mathematical model of a set of multiple mathematical models for predicting the sequence of values for the at least one parameter.

Some examples of the method, apparatuses, and non-transitory computer-readable medium described herein may further include operations, features, means, or instructions for transmitting, to the network entity, a channel state information report including a first portion and a second portion, the first portion including an indication of the quantity of bits and the second portion including the bits of the at least the subset of encoded sequences of predicted values.

In some examples of the method, apparatuses, and non-transitory computer-readable medium described herein, the at least one parameter includes one or more reference signal received powers, one or more signal-to-interference-plus-noise ratios, or both.

In some examples of the method, apparatuses, and non-transitory computer-readable medium described herein, transmitting the message to the network entity may include operations, features, means, or instructions for transmitting a channel state information report or a medium access control control element to the network entity, where the channel state information report or the medium access control control element includes the bits of the encoded sequences of predicted values.

In some examples of the method, apparatuses, and non-transitory computer-readable medium described herein, each beam of the set of multiple beams corresponds to a respective beam-pair of a set of multiple beam-pairs for communications between the UE and the network entity.

A method for wireless communication at a network entity is described. The method may include transmitting a set of multiple reference signals via a first set of multiple beams, receiving, from a UE, a message including a set of bits based on transmitting the set of multiple reference signals, where a total quantity of bits in the set of bits is based on an uncertainty value associated with sequences of predicted values for at least one parameter, the sequences of predicted values associated with a second set of multiple beams, and performing one or more decoding operations on the set of bits based on the uncertainty value, where the network entity identifies the sequences of predicted values based on performing the one or more decoding operations.

An apparatus for wireless communication at a network entity is described. The apparatus may include a processor, memory coupled with the processor, and instructions stored in the memory. The instructions may be executable by the processor to cause the apparatus to transmit a set of multiple reference signals via a first set of multiple beams, receive, from a UE, a message including a set of bits based on transmitting the set of multiple reference signals, where a total quantity of bits in the set of bits is based on an uncertainty value associated with sequences of predicted values for at least one parameter, the sequences of predicted values associated with a second set of multiple beams, and perform one or more decoding operations on the set of bits based on the uncertainty value, where the network entity identifies the sequences of predicted values based on performing the one or more decoding operations.

Another apparatus for wireless communication at a network entity is described. The apparatus may include means for transmitting a set of multiple reference signals via a first set of multiple beams, means for receiving, from a UE, a message including a set of bits based on transmitting the set of multiple reference signals, where a total quantity of bits in the set of bits is based on an uncertainty value associated with sequences of predicted values for at least one parameter, the sequences of predicted values associated with a second set of multiple beams, and means for performing one or more decoding operations on the set of bits based on the uncertainty value, where the network entity identifies the sequences of predicted values based on performing the one or more decoding operations.

A non-transitory computer-readable medium storing code for wireless communication at a network entity is described. The code may include instructions executable by a processor to transmit a set of multiple reference signals via a first set of multiple beams, receive, from a UE, a message including a set of bits based on transmitting the set of multiple reference signals, where a total quantity of bits in the set of bits is based on an uncertainty value associated with sequences of predicted values for at least one parameter, the sequences of predicted values associated with a second set of multiple beams, and perform one or more decoding operations on the set of bits based on the uncertainty value, where the network entity identifies the sequences of predicted values based on performing the one or more decoding operations.

Some examples of the method, apparatuses, and non-transitory computer-readable medium described herein may further include operations, features, means, or instructions for transmitting, to the UE, an indication of a configuration for determining the uncertainty value for the sequences of predicted values.

In some examples of the method, apparatuses, and non-transitory computer-readable medium described herein, performing the one or more decoding operations may include operations, features, means, or instructions for performing the one or more decoding operations based on a configuration for determining the uncertainty value based on the total quantity of bits in the set of bits.

Some examples of the method, apparatuses, and non-transitory computer-readable medium described herein may further include operations, features, means, or instructions for determining the uncertainty value associated with the sequences of predicted values based on the total quantity of bits in the set of bits.

Some examples of the method, apparatuses, and non-transitory computer-readable medium described herein may further include operations, features, means, or instructions for transmitting a request to the UE to transmit the message based on a ranking of the sequences of predicted values, where the uncertainty value for the sequences of predicted values may be based on an average of a set of uncertainty values for the sequences of predicted values.

Some examples of the method, apparatuses, and non-transitory computer-readable medium described herein may further include operations, features, means, or instructions for transmitting a request to the UE to transmit the message based on a ranking of the sequences of predicted values, where the uncertainty value for the sequences of predicted values may be based on a maximum uncertainty value of a set of uncertainty values for the sequences of predicted values.

Some examples of the method, apparatuses, and non-transitory computer-readable medium described herein may further include operations, features, means, or instructions for transmitting a request to the UE to transmit the message based on a ranking of the sequences of predicted values, where the uncertainty value for the sequences of predicted values may be based on a comparison of respective values of the at least one parameter, each respective value corresponding to a respective sequence of values.

In some examples of the method, apparatuses, and non-transitory computer-readable medium described herein, receiving the message from the UE may include operations, features, means, or instructions for receiving the message including the bits, where the bits correspond to a quantity of the sequences of predicted values having respective rankings that satisfy a threshold.

Some examples of the method, apparatuses, and non-transitory computer-readable medium described herein may further include operations, features, means, or instructions for receiving, from the UE, an indication of a configuration for determining the uncertainty value.

In some examples of the method, apparatuses, and non-transitory computer-readable medium described herein, the configuration for determining the uncertainty value corresponds to a mathematical model of a set of multiple mathematical models for predicting the sequences of values for the at least one parameter.

Some examples of the method, apparatuses, and non-transitory computer-readable medium described herein may further include operations, features, means, or instructions for transmitting, to the UE, an indication of a configuration for determining the total quantity of bits based on the uncertainty value, the configuration indicating a mapping between one or more ranges of uncertainty values and respective total quantities of bits.

In some examples of the method, apparatuses, and non-transitory computer-readable medium described herein, transmitting the indication of the configuration may include operations, features, means, or instructions for transmitting, to the UE, a channel state information report configuration including the indication, a medium access control control element that activates a channel state information report including the indication, or downlink control information that activates the channel state information report including the indication, where the channel state information report includes the set of bits.

In some examples of the method, apparatuses, and non-transitory computer-readable medium described herein, each beam of the first set of multiple beams corresponds to a respective beam-pair of a first set of multiple beam-pairs for communications between the network entity and the UE and each beam of the second set of multiple beams corresponds to a respective beam-pair of a second set of multiple beam-pairs for the communications between the network entity and the UE.

### BRIEF DESCRIPTION OF THE DRAWINGS

FIG. 1 illustrates an example of a wireless communications system that supports techniques for beam management in accordance with one or more aspects of the present disclosure.

FIG. 2 illustrates an example of a wireless communications system that supports techniques for beam management in accordance with one or more aspects of the present disclosure.

FIGS. 3A and 3B illustrate examples of block diagrams that support techniques for beam management in accordance with one or more aspects of the present disclosure.

FIG. 4 illustrates an example of a process flow that supports techniques for beam management in accordance with one or more aspects of the present disclosure.

FIGS. 5 and 6 illustrate block diagrams of devices that support techniques for beam management in accordance with one or more aspects of the present disclosure.

FIG. 7 illustrates a block diagram of a communications manager that supports techniques for beam management in accordance with one or more aspects of the present disclosure.

FIG. 8 illustrates a diagram of a system including a device that supports techniques for beam management in accordance with one or more aspects of the present disclosure.

FIGS. 9 and 10 illustrate block diagrams of devices that support techniques for beam management in accordance with one or more aspects of the present disclosure.

FIG. 11 illustrates a block diagram of a communications manager that supports techniques for beam management in accordance with one or more aspects of the present disclosure.

FIG. 12 illustrates a diagram of a system including a device that supports techniques for beam management in accordance with one or more aspects of the present disclosure.

FIGS. 13 through 16 illustrate flowcharts showing methods that support techniques for beam management in accordance with one or more aspects of the present disclosure.

### DETAILED DESCRIPTION

Some wireless communications systems may support techniques for directional communications using one or more beams. In such wireless communications systems, communication devices may perform beam management operations, which may include operations to select beams (e.g., beam-pairs) for communications (e.g., preferred beams, optimal beams) based on one or more parameters. For example, a network entity may transmit multiple reference signals to a user equipment (UE) using different beams (e.g., the network entity may perform a beam sweeping procedure). The UE may then measure the reference signals and determine one or more parameters (e.g., reference signal received powers (RSRPs), signal-to-interference-plus-noise ratios (SINRs)) for each reference signal. The UE may utilize the one or more parameters (e.g., compare the one or more parameters) to determine one or more beams for communications (e.g., one or more beams with RSRPs that satisfy a threshold). In some cases, communication devices may perform predictive beam management operations to predict one or more parameters based on measuring reference signal parameters, which may conserve communication resources (e.g., beam refinement may be accelerated using predicted values for the one or more parameters). To predict the one or more parameters, a UE may utilize a mathematical model, such as a machine learning algorithm. However, some communication devices may not account for uncertainty associated with predictive beam management operations when selecting beams (e.g., preferred beam-pairs), which may limit an ability of a communication device to effectively select beams. For example, communication devices may not consider uncertainty during beam management operations. In addition, a UE may report a large payload size (e.g., a large quantity of bits) for beam reporting (e.g., for communication parameters for beam management) regardless of complexity of conveying the predicted parameter values (e.g., regardless of whether prediction uncertainty is high or low).

In accordance with aspects of the present disclosure, a UE may improve utilization of communication resources and effectiveness of predictive beam management operations by communicating uncertainty information and predicted beam parameters using variable bit-width signaling, such that information with a relatively low uncertainty value is communicated using fewer bits than information with a relatively high uncertainty value. In such cases, a UE may predict a sequence of values for one or more parameters (e.g., Layer 1 RSRPs, Layer 1 SINRs) and may perform respective encoding operations on the predicted sequences of values. The respective encoding operations may output a quantity of bits based at least in part on an uncertainty value (e.g., a total uncertainty value, an overall uncertainty value) for the sequences of predicted values. The UE may then transmit a message to a network entity including the bits (e.g., the bits of the encoded sequences of predicted values).

Accordingly, the UE and the network entity may select one or more beams (e.g., beam-pairs) for communications based on the uncertainty value for the sequences of predicted values.

Aspects of the disclosure are initially described in the context of wireless communications systems. Aspects of the disclosure are further illustrated by and described with reference to block diagrams, a process flow, apparatus diagrams, system diagrams, and flowcharts that relate to techniques for beam management.

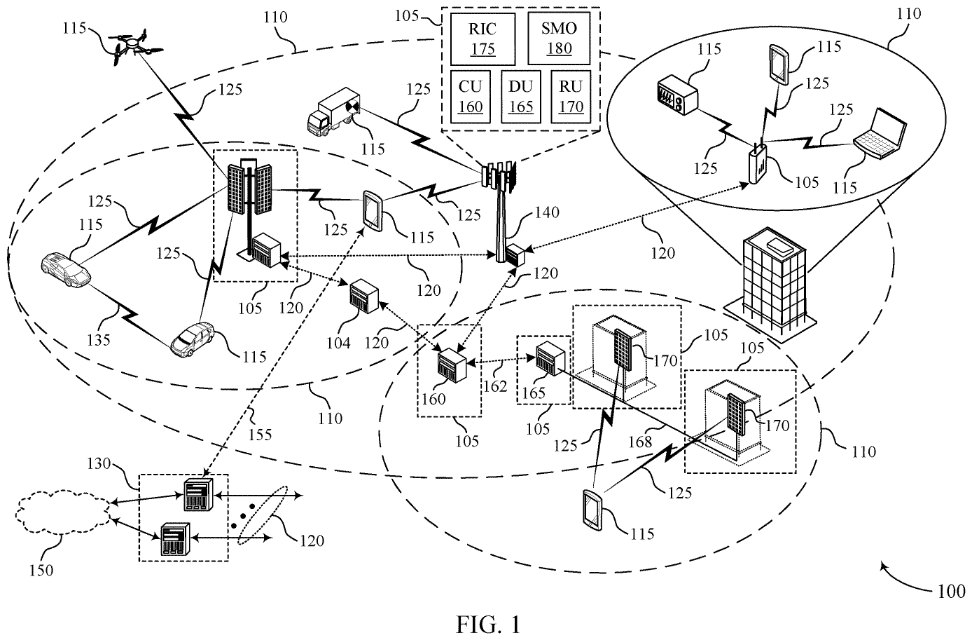

FIG. 1 illustrates an example of a wireless communications system 100 that supports techniques for beam management in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for beam management as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In a wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some aspects, the wireless communications system 100 may support one or more beam management techniques. For example, a UE 115 may be in an RRC idle state (e.g., RRC_IDLE) or an RRC inactive state (e.g., RRC_INACTIVE) and may transmit or receive one or more tracking reference signals (TRSs) prior to initial access. As part of initial access, one or more devices (e.g., one or both of a UE 115 and a network entity 105) may perform synchronization signal block (SSB) beam sweeping (e.g., wide beam sweeping). In some aspects, initial access may involve a contention based random access (CBRA) procedure associated with transmission or reception of random access preambles via random access channel (RACH) occasions (ROs) or transmission or reception of SSBs or a contention free random access (CFRA) procedure.

Upon establishment of a beam pair between two devices (e.g., between a UE 115 and a network entity 105), each device may perform beam management in an RRC connected state (e.g., RRC_CONNECTED). In some aspects, such beam management may include transmission or reception of one or more SSBs, one or more CSI reference signals (CSI-RSs), or one or more sounding reference signals (SRSs), Layer 1 (L1) reference signal receive power (RSRP) reporting, and transmission configuration indicator (TCI) state configuration or indication. In some aspects, beam management (e.g., SSB or CSI-RS associated beam management) may be associated with a set of processes P1, P2, and P3 that are designed for beam management while a device is in a connected state. P1 may be associated with beam selection (e.g., a network entity 105 may sweep a beam and a UE 115 may select one of the beams and report the selected beam to the network entity 105), P2 may be associated with beam refinement for the transmitter (e.g., a network entity 105 may refine a beam via sweeping a narrower beam across a narrower range and a UE 115 may select one of the narrower beams and report the selected narrower beam to the network entity 105), and P3 may be associated with beam refinement for the receiver (e.g., a network entity 105 may fix a beam (e.g., repeat transmissions using a beam) and a UE 115 may refine its receive beam). In some aspects, beam management (e.g., SRS associated beam management) may be associated with a set of different uplink beam management procedures U1, U2, and U3, where each beam management procedure may be associated with a beam sweep.

Additionally, or alternatively, beam management may include L1 signal-to-interference-plus-noise ratio (SINR) reporting and overhead and latency reduction. In some aspects, overhead and latency reduction may be associated with or otherwise involve one or more component carrier (CC) group beam updates and lower latency uplink beam updates. Further, in some aspects, beam management may involve beam measurement or reporting, or both, with association to unified TCI states and L1 or Layer 2 (L2) centric mobility. For example, beam management procedures may include dynamic TCI state updates, uplink multi-panel selection, maximum permissible exposure (MPE) mitigation, or other techniques that facilitate further beam management latency reduction. Further, some beam management procedures may include procedures associated with high speed train (HST) deployments, single frequency network (SFN) deployments, or multi-TRP deployments, or any combination thereof.

In some aspects, a device may measure, identify, or otherwise experience a beam failure detection (BFD) based on measurements associated with beam management and may perform one or more beam failure recovery procedures. BFD and beam failure recovery (BFR) may be performed for a primary cell (PCell), a primary secondary cell (PSCell), or a secondary cell (SCell). Further, BFD and BFR may involve transmission or reception of one or more BFD reference signals (BFD-RSs), a physical downlink control channel (PDCCH) block error rate (BLER) measurement, a link recovery request via a scheduling request (SR), or a MAC control element (MAC-CE) based BFR for SCell, or any combination thereof. In some cases, such as in cases in which a device is unable to recover a failed beam pair link, the device may declare a radio link failure (RLF) and attempt to re-establish a connection via one or more initial establishment procedures.

Various devices of the wireless communications system 100 may support one or more AI or ML models associated with air-interface predictions (e.g., predictions associated with wireless communication). In some deployments, for example, a device may leverage or use an AI or ML model for CSI feedback enhancement (e.g., for overhead reduction and more accurate prediction), beam management (e.g., beam prediction in a time or a spatial domain for overhead and latency reduction as well as for greater beam selection accuracy), or positioning accuracy enhancements for different scenarios (e.g., scenarios associated with non-line-of-sight (NLOS) conditions).

In some cases, the device may leverage or use an AI or ML model for a specific use case such that the AI or ML model approach is diverse enough to support various constraints on collaboration levels between a UE 115 and a network entity 105. Further, various devices may support one or both of an AI or ML model or description to identify common and specific characteristics for framework investigations or decisions. For example, devices may support a model and description to characterize lifecycle management of an AI or ML model, such as aspects relating to model training, model deployment, model inference, model monitoring, or model updating.

In some deployments, a UE 115 or a network entity 105 may use AI or ML based predictive beam management (e.g., for Uu beam management). For example, other beam management techniques may involve an identification of beam qualities or failures via measurements, which may be associated with greater power or overhead to achieve suitable performance. Further, measurement-based beam management may be associated with a limited accuracy due to constraints on power or overhead and latency and throughput may be adversely impacted by beam resumption efforts. Predictive beam management, on the other hand, may be associated with power or overhead reduction, greater accuracy, lower latency, or higher throughput. For example, a predictive beam management procedure may enable a device to predict non-measured beam qualities (which may be associated with lower power consumption, lower overhead, or greater beam selection accuracy) and to predict future beam blockages or failures (which may be associated with lower latency and greater throughput). Such predictive beam management may involve predictions in a spatial domain, a time domain, a frequency domain, or any combination thereof.

Some devices may specifically employ AI or ML to compensate for or address that beam prediction may be a highly non-linear problem in some deployments. For example, predicting a future transmit beam quality may depend on a speed or trajectory of a UE 115, one or more receive beams that are to be used, or interference, among other examples, which may be difficult to model via some statistical signaling processing methods (e.g., non-AI or ML based statistical processing methods). In some deployments, there may be a tradeoff between performance and UE power consumption based on whether beam prediction is performed at a UE 115 or a network entity 105. For example, to predict future downlink transmit beam qualities, a UE 115 may have more observations (e.g., via measurements) than a network entity 105 (e.g., via UE feedback messages), thus beam prediction at a UE 115 may outperform beam prediction at a network entity 105 (at the cost of consuming more UE power for the prediction or inference processing tasks). Further, model training may be performed at either a UE 115 or a network entity 105 and a decision between training location may be associated with efforts on data collection as compared to efforts on UE computation. For example, if training is performed by a network entity 105, data may be collected via an air interface or via application layer approaches. If training is performed by a UE 115, the UE 115 may perform additional UE computation or buffering tasks for the model training and associated data storage.

In some cases, a time series of L1 RSRPs may be input to a machine learning model. The time series may include L1 RSRPs reported by a UE 115 (e.g., for prediction at a network entity 105). In some other cases, the time series may include L1 RSRPs measured by the UE 115 (e.g., for prediction at the UE 115). The time series may include RSRPs that are measured or reported at different time instances. In some cases, the RSRPs may correspond to different CSI RS or SSB resource identifiers. The machine learning model may output a set of targets (e.g., target 1, target 2, and target 3). Target 1 may correspond to (e.g., may be for) predicted L1 RSRPs. Target 2 may correspond to (e.g., may be for) predicted candidate beams. Target 3 may correspond to (e.g., may be for) predicted beam failure or blockage. In some cases, the machine learning model may provide one or more benefits such as reduced power consumption, reduced reference signaling, reduced overhead, reduced latency, and increased throughput.

AI or ML-based spatial domain or time domain beam prediction or selection (e.g., for downlink) may relate to one or more of various procedures. For example, AI or ML-based spatial domain or time domain beam prediction or selection may be used for initial access, secondary cell group (SCG) setup, serving beam refinement, link quality and interference adaptation (e.g., for one or more parameters, such as a channel quality indicator (CQI) or a precoding matrix indicator (PMI)), beam failure or blockage prediction, or RLF prediction. In some aspects, specific selection or prediction schemes may be used for each of such various procedures. For example, codebook-based spatial domain selection may be used for initial access, SCG setup, serving beam refinement, or link quality and interference adaptation. Non-codebook-based spatial domain prediction may be used for serving beam refinement and link quality and interference adaptation. Additionally, or alternatively, joint spatial domain and time domain beam prediction may be used for serving beam refinement, link quality and interference adaptation, beam failure or blockage prediction, or RLF failure prediction.

Codebook-based spatial domain selection may be associated with an input of a first set of beams (e.g., measurements of a first set of beams) and a predicted output (e.g., an output of an AI or ML model) of a second set of beams (e.g., a predicted set of beams). For interference at a network entity 105, the input may be associated with or include UE feedbacks and side information (e.g., history or location information. For inference at a UE 115, the input may be associated with or include UE measurements and side information (e.g., location information). A UE 115 may report or measure such measurement information using spatial domain or time domain compressive beam measurements. Codebook-based spatial domain selection may be associated with fewer beam measurements, which may lead to power reduction at a measuring device (e.g., a UE 115).

Non-codebook-based spatial domain prediction may be associated with an input of a set of channels or beams (e.g., measurements associated with a set of channels or beams) and an output of a point direction, an angle of departure (AoD), or an angle of arrival (AoA). For inference at a network entity 105, the input may be associated with or include UE feedbacks and side information (e.g., history or location information). For inference at a UE 115, the input may be associated with or include UE measurements and side information (e.g., location information). Such reporting or measuring of such measurement information at a UE 115 may be facilitated via raw channel extraction. Non-codebook-based spatial domain prediction may be associated with greater beam management accuracy without excessive beam sweepings.

From spatial domain to spatial domain plus time domain, joint spatial domain and time domain beam prediction may be associated with a time series input and outputs associated with both codebook-based spatial domain and time domain beam prediction and non-codebook-based spatial domain and time domain point direction, AoD, or AoA prediction. The time series input may include a UE report or measurement at a first time or measurement occasion (e.g., a measurement occasion #0) through a UE report or measurement at an N^{th} time or measurement occasion (e.g., a measurement occasion #N). In accordance with the joint spatial domain and time domain beam prediction, the time series input may be input to a first AI or ML model to obtain a first output of codebook-based spatial domain and time domain beam prediction and may be input to second AI or ML model to obtain a second output of non-codebook-based spatial domain and time domain point direction, AoD, or AoA prediction.

Prediction performance or costs may depend on whether prediction is performed by a UE 115 or a network entity 105. If prediction is performed at a network entity 105, the network entity 105 may use relatively more powerful computational capabilities (e.g., as compared to a UE 115), access to historical and location-wise L1 report distributions, access to feedbacks or locations of other UEs 115, awareness of transmit beam shapes and pointing directions to assist in beam prediction. In some deployments, prediction performance at the network entity 105 may be balanced with other factors, such as that only a strongest one or more beams may be reported by a UE 115, a difficulty to know receive beams used to derive the L1 or CSI feedbacks, (all) UE feedbacks being quantized (and could potentially be missed), and that it may be difficult to know an orientation or rotation status of a UE 115. If beam prediction is performed at a UE 115, the UE 115 may use access to instantaneous and filtered measurements of a set of (e.g., all) beams, access to the receive beams used to derive the measurements, (all) measurements being raw or non-quantized, and an awareness (at least in part) of or an ability to predict its own orientation and rotation to assist in beam prediction. In some deployments, prediction performance at the UE 115 may be balanced with other factors, such as that the UE 115 may have relatively limited computational capabilities, relatively limited knowledge on historical distribution of L1 reports in the cell, a difficulty to access L1 or CSI feedbacks of other UEs 115, or a relatively limited indication or perception on transmit beam shapes or pointing directions.

A UE 115 may receive control signaling from a network entity 105 that indicates, configures, activates, or triggers a CSI report from the UE 115. For example, a UE 115 may be configured to transmit one or more synchronization signal (SS)/physical broadcast channel (PBCH) resource indicator (SSBRI) or a CSI-RS resource indicator (CRI) and L1-reference signal receive power (RSRP) or L1-signal-to-interference-plus-noise ratio (SINR) reports via one or more CSI reports. In some deployments, a UE 115 may receive (e.g., be configured with) a ReportQuantity=ssb-Index-RSRP, ssb-Index-SINR, cri-RSRP, or cri-SINR for joint SSBRI/CRI and L1-RSRP/L1-SINR beam reporting. The UE 115 may report (e.g., transmit) a nrofReportedRS parameter (which may be RRC configured, and may be up to 2 or 4 depending on UE capability), which may be different for SSBRI or CRI for each CSI-ReportConfig.

For L1-RSRP reporting, for a strongest SSBRI/CRI, 7 bits may be used to report RSRP in a range of [−140, −44] dBm with a 1 dBm step size. For remaining SSBRI(s)/CRI(s), 4 bits may be used to report a differential RSRP in a range of [0, −30] dB with a 2 dB step size and a reference to the L1-RSRP of the strongest SSBRI/CRI (e.g., the greatest RSRP reported, in absolute or full terms, via the 7 bits). For the L1-RSRP of the strongest SSBRI/CRI, there may be one or more invalid codepoints considering that 27=128 but 140−44+1=97. In some systems, a mapping between the reported 7-bit and 4-bit codepoints and the actually measured RSRP values may be defined by a specification, such as a network specification.

Similarly, for L1-SINR reporting, for a strongest SSBRI/CRI, 7 bits may be used to report SINR in a range of [−23, 40] dB with a 0.5 dB step size. For remaining SSBRI(s)/CRI(s), 4 bits may be used to report a differential SINR in a range of [0, −15] dB with a 1 dB step size and a reference to the L1-SINR of the strongest SSBRI/CRI (e.g., the greatest SINR reported, in absolute or full terms, via the 7 bits). For the strongest and the remaining SSBRI(s)/CRI(s), there may be no invalid codepoints, but SINR_0 may stand for an SINR of less than or equal to −23 dB for the strongest SSBRI/CRI, while DIFFSINR_15 may stand for a delta SINR of less than or equal to 15 dB. In some systems, a mapping between the reported 7-bit and 4-bit codepoints and the actually measured SINR values may be defined by a specification, such as a network specification.

In some deployments, devices of the wireless communications system 100 may support, for AI or ML-based beam management, one or more beam management cases for characterization and baseline performance evaluations. A first beam management case, or BM-Case1, may be associated with spatial domain downlink beam prediction for a set A of beams based on measurement results of a set B of beams. A second beam management case, or BM-Case2, may be associated with temporal downlink beam prediction for a set A of beams based on historic (e.g., previous) measurement results of a set B of beams.

Beams of the set A and the set B may be in a same frequency range or in different frequency ranges. In some aspects, set B may be a subset of set A, where the number of beams in set A and in set B may vary. In some other aspects, set A and set B may be different. For example, set A may include a set of relatively narrower beams and set B may include a set of relatively wider beams. In such aspects, where the number of beams in set A and in set B may vary and there may be a defined quasi-colocation (QCL) relation between beams in set A and beams in set B. Further, various types or implementations of codebook constructions of set A and set B may be used without exceeding the scope of the present disclosure. In the context of such a set A of beams and a set B of beams, set A may be for downlink beam prediction and set B may be for downlink beam measurement.

The wireless communications system 100 may support techniques for directional communications using one or more beams. Accordingly, the UEs 115 and the network entities 105 may perform beam management operations, which may include operations to select beams (e.g., beam-pairs) for communications (e.g., preferred beams, optimal beams) based on one or more parameters. For example, a network entity 105 may transmit multiple reference signals to a UE 115 using different beams (e.g., the network entity 105 may perform a beam sweeping procedure). The UE 115 may then measure the reference signals and determine one or more parameters (e.g., RSRPs, SINRs) for each reference signal. The UE 115 may utilize the one or more parameters (e.g., compare the one or more parameters) to determine one or more beams for communications (e.g., one or more beams with RSRPs that satisfy a threshold).

In some cases, communication devices (e.g., the UEs 115 and the network entities 105) may perform predictive beam management operations to predict one or more parameters rather than measuring reference signal parameters, which may conserve communication resources (e.g., in such cases reference signals may not be transmitted). To predict the one or more parameters, a communication device (e.g., a UE 115, a network entity 105) may utilize a mathematical model, such as a machine learning algorithm. However, some communication devices may not account for uncertainty associated with predictive beam management operations when selecting beams (e.g., preferred beam-pairs), which may limit an ability of a communication device to effectively select beams. For example, communication devices may not consider uncertainty during beam management operations. In addition, a UE 115 may report a large payload size (e.g., a large quantity of bits) for beam reporting (e.g., for communication parameters for beam management) regardless of complexity of conveying the predicted parameter values (e.g., regardless of whether prediction uncertainty is high or low).

In accordance with aspects of the present disclosure, a communication device (e.g., a UE 115, a network entity 105) may improve utilization of communication resources and effectiveness of predictive beam management operations by communicating uncertainty information and information for predicted beam parameters using variable bit-width signaling, such that information with a relatively low uncertainty value is communicated using fewer bits than information with a relatively high uncertainty value. In such cases, a UE 115 may predict a sequence of values for one or more parameters (e.g., Layer 1 RSRPs, Layer 1 SINRs) and may perform respective encoding operations on the predicted sequences of values. The respective encoding operations may output a quantity of bits based at least in part on an uncertainty value (e.g., a total uncertainty value, an overall uncertainty value) for the sequences of predicted values. The UE 115 may then transmit a message to a network entity 105 including the bits (e.g., the bits of the encoded sequences of predicted values). Accordingly, the UE 115 and the network entity 105 may select one or more beams (e.g., beam-pairs) for communications based on the uncertainty value for the sequences of predicted values.

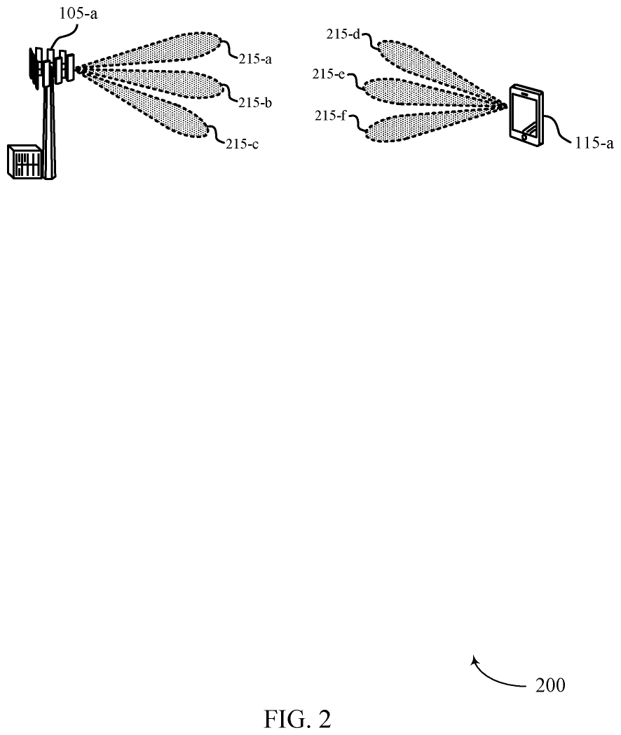

FIG. 2 illustrates an example of a wireless communications system 200 that supports techniques for beam management in accordance with one or more aspects of the present disclosure. The wireless communications system 200 may include or otherwise implement one or more aspects of the wireless communications system 100. For example, the wireless communications system 200 may include a UE 115-a and a network entity 105-a, which may be examples of UEs 115 and network entities 105 as described with reference to FIG. 1.

As described herein, the UE 115-a and the network entity 105-a may communicate (e.g., directionally) using one or more beams 215. For example, the network entity 105-b may transmit downlink communications to the UE 115-a or receive uplink communications from the UE 115-a using a beam 215-a, a beam 215-b, or a beam 215-c. The UE 115-a may receive downlink communications from the network entity 105-a or transmit uplink communications to the network entity 105-a using a beam 215-d, a beam 215-e, or a beam 215-f. In some cases, the UE 115-a and the network entity 105-a may select a beam-pair for communications, which may include a beam 215 used by the UE 115-a and a beam 215 used by the network entity 105-a. For example, the beam 215-a and the beam 215-d may be an illustrative example of a beam pair.

The UE 115-a and the network entity 105-a may perform one or more beam management operations to select one or more beams 215 for communications. For example, the network entity 105-a may perform a beam sweeping operation, which may enable the UE 115-a to measure one or more parameters for each beam 215 included in the beam sweeping operation. As part of a beam sweeping operation, the network entity 105-a may transmit multiple signals (e.g., reference signals) using multiple beams 215. For example, the network entity 105-a may transmit a first reference signal using the beam 215-a, a second reference signal using the beam 215-b, and a third reference signal using the beam 215-c. The network entity 105-b may transmit each reference signal simultaneously or at different times. Although the illustrative example of a beam sweeping operation described with reference to FIG. 2 includes the beam 215-a, the beam 215-b, and the beam 215-c, the network entity 105-a may transmit any quantity of reference signals using any quantity of beams 215.

The UE 115-a may receive one or more signals (e.g., reference signals) from the network entity 105-a (e.g., reference signals transmitted by the network entity 105-a as part of a beam sweeping operation). The UE 115-a may measure one or more parameters for each reference signal. For example, the one or more parameters may include an RSRP, a SINR, or any other parameter. The one or more parameters may indicate a quality or a power of a signal, which may indicate (e.g., implicitly) a quality or power for a beam 215. For example, the network entity 105-a may transmit a first reference signal using the beam 215-a and a second reference signal using the beam 215-b. The UE 115-a may determine that a first RSRP of the first reference signal is greater than a second RSRP of the second reference signal. Accordingly, the UE 115-a may determine that the beam 215-a should be used for communications as an alternative to the beam 215-b. The UE 115-a may transmit an indication to the network entity 105-a requesting that the network entity 105-a use the beam 215-a for communications with the UE 115-a.

In some cases, communication devices may perform one or more operations to predict parameters for beams 215 (e.g., values of parameters, sequences of predicted values). For example, a UE 115-a may perform one or more mathematical computations (e.g., perform or otherwise execute a mathematical algorithm) to predict an RSRP for a beam 215 (e.g., a candidate beam for future communications, a hypothetical beam for future communications). In some cases, a device or system other than the UE 115-a or the network entity 105-a may perform the one or more operations to predict parameters for beams 215. For example, a cloud-based computing system or other decentralized device may perform the one or more operations to predict the parameters. In such cases, a communication device (e.g., the UE 115-a, the network entity 105-a) may initiate the one or more operations to predict the parameters. For example, the UE 115-a may transmit an indication (e.g., a message) to a cloud-based system, which may perform one or more operations to predict the parameters based on receiving the indication from the UE 115-a.

In some cases, beam management (e.g., predictive beam management) may include spatial beam prediction, temporal beam prediction, or both. In some cases, predictive beam management (e.g., predicting parameters for beams 215) may include predicting parameters (e.g., for hypothetical beams, for future signaling) based on previously measured parameters or data otherwise associated with prior information. For example, a UE 115-a may measure parameters for a first set of beams 215 and may predict parameters for a second set of beams 215 based on the measured parameters for the first set of beams 215. In some cases, the second set of beams 215 may be narrower than the first set of beams 215. Accordingly, the UE 115-a may utilize the measured parameters for the first set of beams 215 to predict parameters for the second set of beams 215. Based on the predicted parameters, in some cases the UE 115-a may select a beam 215 for communications without measuring a reference signal transmitted using the beam 215.

In some cases, communication devices may perform encoding operations (e.g., compression operations) and decoding operations (e.g., decompression operations). For example, the UE 115-a and the network entity 105-a may each include one or more encoders and one or more decoders. In some cases, a communication device may utilize an encoder to compress information prior to transmitting the information. For example, an encoder may convert information into a sequence of values, such as a sequence of bits. Additionally, or alternatively, a decoder may convert a sequence of values, such as a sequence of bits into information.

In some cases, a communication device (e.g., a UE 115-a, a network entity 105-a) may predict a sequence of values (e.g., a sequence of bits, a bitmap) for each beam 215 of a set of beams 215. Each sequence of predicted values may be for a parameter (e.g., a sequence may represent or otherwise indicate a value of a parameter). In some cases, a communication device may utilize an encoder to compress (e.g., encode) a predicted sequences of values. In some cases, a UE 115-a may predict a sequence of values for each beam 215 of a set of beams 215. That is, the UE 115-a may predict one sequence of values for each beam 215. As an illustrative example, each sequence of values may represent or otherwise indicate a respective RSRP for a respective reference signal transmitted by the network entity 105-a using a respective beam 215.

Each sequence of predicted values (e.g., each prediction) may have an associated uncertainty. For example, the uncertainty may indicate a likelihood that the prediction is accurate or a variability (e.g., variance) associated with the prediction. The uncertainty may indicate a deviation from a mean value for a quantity of predictions (e.g., a standard deviation). In some cases, a quantity of bits used to communicate information (e.g., a prediction) with a relatively high uncertainty (e.g., a high complexity) may be greater than a quantity of bits used to indicate information with a relatively low uncertainty (e.g., a low complexity). For example, if a prediction of an L1 RSRP is relatively complex (e.g., less certain) when compared to other predictions, a greater quantity of bits may be used to describe the prediction (e.g., indicate the prediction) when compared to other predictions (e.g., less complex predictions, more certain predictions).

However, some communication devices may not account for uncertainty associated with predictive beam management operations when selecting beams 215 (e.g., preferred beam-pairs), which may limit an ability of a communication device to effectively select beams 215. For example, a communication device may select a beam 215 based on one or more predicted parameters with high uncertainties and the predicted parameters may not accurately characterize the beam 215. In addition, a UE 115-a may report a large payload size (e.g., a large quantity of bits) for beam reporting (e.g., for communication parameters for beam management) regardless of complexity of the predicted parameter values (e.g., regardless of whether prediction uncertainty is high or low), which may increase signaling overhead (e.g., physical uplink control channel (PUCCH) overhead for L1 reports).

In accordance with aspects of the present disclosure, a communication device (e.g., the UE 115-a, the network entity 105-a) may improve utilization of communication resources and effectiveness of predictive beam management operations by communicating uncertainty information and information for predicted beam parameters using variable bit-width signaling, such that information with a relatively low uncertainty value is communicated using fewer bits than information with a relatively high uncertainty value. In such cases, a communication device may implement an encoder (e.g., an autoencoder) to compress sequences of values (e.g., L1 reports). As described herein, the terms “encoder” and “autoencoder” may be used interchangeably to describe variable bit-width encoding operations where a bit width of an encoder output is based on an uncertainty value of the encoder input.

In some cases, a UE 115-a may predict a sequence of values for one or more parameters (e.g., L1 RSRPs, L1 SINRs) and may perform respective encoding operations on the predicted sequences of values. The respective encoding operations may output a quantity of bits based at least in part on an uncertainty value (e.g., a total uncertainty value, an overall uncertainty value) for the sequences of predicted values. The UE 115-a may then transmit a message to a network entity 105-a including the bits (e.g., the bits of the encoded sequences of predicted values). Accordingly, the UE 115-a and the network entity 105-a may select one or more beams 215 (e.g., beam-pairs) for communications based on the uncertainty value for the sequences of predicted values.

Additionally, or alternatively, the UE 115-a and the network entity 105-a may perform one or more additional operations to verify (e.g., check) an accuracy of a prediction (e.g., a prediction with a high uncertainty) based on determining and signaling uncertainty values for predicted sequences of values. For example, a prediction (e.g., a sequence of predicted values) may have a relatively high uncertainty and a relatively high L1 RSRP when compared to other predictions, which may indicate that a beam 215 corresponding to the prediction may provide relatively high performance when compared to other beams 215. Based on the high uncertainty value of the prediction, a network entity 105-a may determine to transmit one or more reference signals using the beam 215 and a UE 115-a may measure the reference signals (e.g., to verify if the prediction is accurate or within a threshold range).

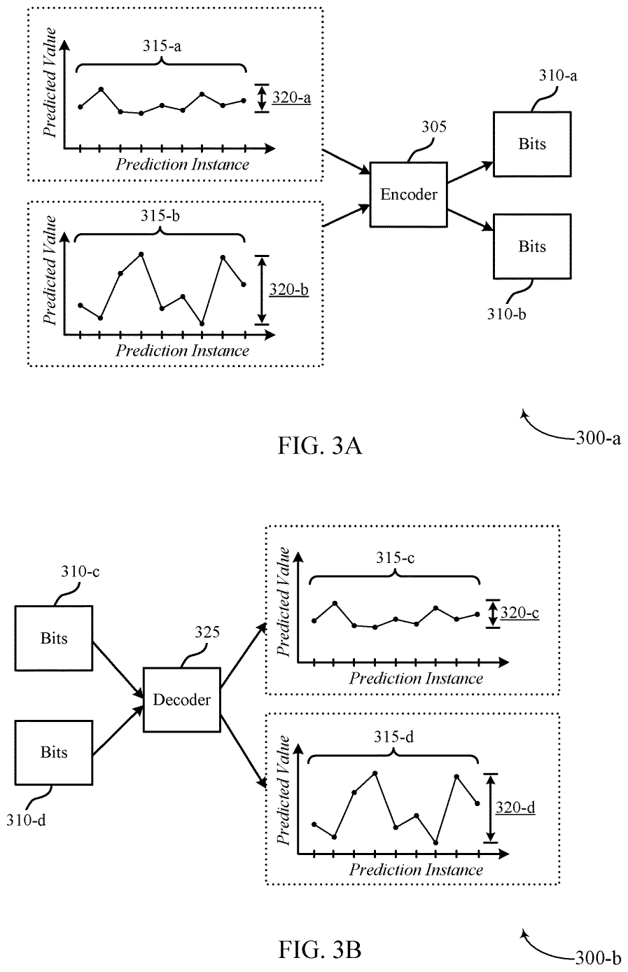

FIG. 3A may illustrate an example of a block diagram 300-a that supports techniques for beam management in accordance with one or more aspects of the present disclosure. One or more aspects of the block diagram 300-a may be implemented by one or more aspects of the wireless communications system 100 or the wireless communications system 200. For example, the block diagram 300-a may include an encoder 305, which may be implemented by or otherwise controlled by a communication device such as a UE 115 or a network entity 105 as described with reference to FIGS. 1 and 2. For example, a UE 115 may include an encoder 305. In some cases, the block diagram 300-a may include bits 310-a and bits 310-b, which may each be output by the encoder 305. Additionally, or alternatively, the block diagram 300-a may include a set of predictions 315-a and a set of predictions 315-b, which may have uncertainty values 320. Although FIG. 3A shows ranges of values as illustrative examples of uncertainty values 320, an uncertainty value 320 may be represented differently (e.g., determined differently) in accordance with examples as described in further detail herein.

The encoder 305 may have one or more inputs and one or more outputs. For example, the encoder 305 may receive information (e.g., predictions) via the one or more inputs, perform one or more operations to compress the information, and transmit the compressed information (e.g., bits 310) via the one or more outputs. In some cases, the encoder 305 (e.g., a UE 115 that includes the encoder 305) may transmit the compressed information to a network entity 105 (e.g., via a CSI report, via a MAC CE). The information may include one or more predictions (e.g., one or more sequences of predicted values). The one or more predictions may be included in a set of predictions 315. In some cases, the information may include an indication of a bit width (e.g., in addition to the one or more predictions). That is, a UE 115 may transmit an output of the encoder 305 including a payload (e.g., one or more sequences of predicted values) and an indication of a bit width. As described herein, the encoder 305 may be a component of or may be otherwise associated with a UE 115 or any other communication device. Accordingly, signaling and communications performed by the encoder 305 may be analogous with signaling and communications performed by a UE 115. For example, a UE 115 may transmit, via the encoder 305, the compressed information to the network entity 105.

In some cases, a UE 115 (e.g., the encoder 305) may receive a request from a network entity 105 to transmit a CSI report or a MAC CE to the network entity 105. The CSI report or the MAC CE may include one or more predictions for a quantity of channel measurement resources (e.g., one or more compressed and predicted L1 RSRPs, one or more compressed and predicted SINRs). In some cases, the one or more predictions may be associated with one or more beams 215 (e.g., one or more beam pairs). The input to the encoder 305 may include the one or more predictions (e.g., predicted L1 RSRPs, predicted L1 SINRs) and one or more uncertainty values 320 for the one or more predictions. The output of the encoder 305 may include variable bit-width signaling (e.g., a quantity of bits 310 output by the encoder 305 may be based on the one or more uncertainty values 320). For example, a relatively high uncertainty value 320 for an L1 RSRP or a SINR may be communicated using a greater quantity of bits 310 when compared to a relatively low uncertainty value 320. In some cases, a UE 115 may report (e.g., transmit) the output of the encoder 305 (e.g., the bits 310-a or the bits 310-b) to a network entity 105 in a CSI report or a MAC CE. In some cases, the CSI report may include an indication of a bit width (e.g., output by the encoder 305) and a payload, where the payload may indicate one or more predictions (e.g., one or more sequences of predicted values). The indication of the bit width may be included in a first portion of a CSI report (e.g., a CSI Part 1), which may have a fixed payload size. The output of the encoder 305 may be included in a second portion of the CSI report (e.g., a CSI Part 2).

An uncertainty value 320 may be determined (e.g., calculated) using different methods (e.g., different options). For example, an uncertainty value 320 may be an example of or may otherwise refer to a standard deviation for a set of values (e.g., a set of predictions 315). The standard deviation for the set of values may be an example of an average variation (e.g., variance) for the set of values. Additionally, or alternatively, an uncertainty value 320 may be an example of or may otherwise refer to a maximum variation (e.g., maximum standard deviation), or a variation (e.g., standard deviation) of a subset of values (e.g., for a single value such as a maximum value). In some cases, a UE 115 may determine (e.g., select, configure) a method for determining uncertainty values 320 (e.g., a type of uncertainty value 320 for predictions). For example, a UE 115 may select whether an uncertainty value 320 is represented by an average variance, a maximum variance, or a variance corresponding to a single prediction (e.g., for a strongest RSRP, for a strongest SINR). In some other cases, a network entity 105 may determine (e.g., select, configure) a method for determining uncertainty values 320 (e.g., a type of uncertainty value 320).

A method for determining one or more uncertainty values 320 (e.g., a type of uncertainty value 320 for reporting) may be based on (e.g., triggered by) a CSI report or any other signaling associated with CSI reporting. For example, a network entity may transmit an indication to a UE 115 that includes a CSI report setting and a method for determining one or more uncertainty values 320. In some cases, the CSI report setting (e.g., a type of the CSI report setting) may indicate (e.g., implicitly) the method for determining the one or more uncertainty values 320. For example, a first type of CSI report setting may correspond to a first method for determining one or more uncertainty values 320, a second type of CSI report setting may correspond to a second method for determining one or more uncertainty values 320, and so forth. In some cases, a method for determining one or more uncertainty values 320 may be indicated via a MAC CE (e.g., a MAC CE that activates periodic CSI reports). Additionally, or alternatively, the method for determining one or more uncertainty values 320 may be triggered via DCI signaling. For example, the configuration may be based on aperiodic CSI trigger state configurations for aperiodic CSI reports.

In some cases, an uncertainty value 320 may be an example of a standard deviation or variance for a set of predictions 315 (e.g., predicted and reported L1 RSRPs, predicted and reported SINRs). A network entity 105 may transmit a request to a UE 115 to report a quantity of predictions for a quantity of beam-pairs. As an illustrative example, the network entity 105 may transmit a request that the UE 115 report the 16 strongest predicted L1 RSRPs, L1 SINRs, or both, associated with 128 beam-pairs. The request may indicate that the UE 115 is to report the quantity of predictions periodically. An uncertainty value 320 for the predictions (e.g., the reported RSRPs, the reported SINRs) may be a mean value of 16 variance values (e.g., for each of the 16 strongest predictions).

In some other cases, an uncertainty value 320 may be an example of a maximum variance (e.g., maximum standard deviation) of all predictions included in a set of predictions 315 (e.g., predicted and reported L1 RSRPs, predicted and reported SINRs). A network entity 105 may transmit a request to a UE 115 to report a quantity of predictions for a quantity of beam-pairs. As an illustrative example, the network entity 105 may transmit a request that the UE 115 report the 16 strongest predicted L1 RSRPs, L1 SINRs, or both associated with 128 beam-pairs. In such cases, an uncertainty value 320 for the predictions (e.g., the reported RSRPs, the reported SINRs) may be a maximum value of 16 variance values (e.g., for each of the 16 strongest predictions).

In some other cases, an uncertainty value 320 may be an example of a variance (e.g., standard deviation) of a single prediction in a set of predictions 315 (e.g., predicted and reported L1 RSRPs, predicted and reported SINRs). For example, an uncertainty value 320 may be a standard deviation for a strongest predicted RSRP or a strongest predicted SINR. A network entity 105 may transmit a request to a UE 115 to report a quantity of predictions for a quantity of beam-pairs. As an illustrative example, the network entity 105 may transmit a request that the UE 115 report the 16 strongest predicted L1 RSRPs, L1 SINRs, or both, associated with 128 beam-pairs. In such cases, an uncertainty value 320 for the predictions (e.g., the reported RSRPs, the reported SINRs) may be a variance value for a strongest prediction of a set of predictions 315 (e.g., a strongest RSRP, a strongest SINR).

A UE 115 may transmit an indication of a type of uncertainty value 320 to a network entity 105. For example, the indication may indicate whether an uncertainty value 320 is a mean value of a set of uncertainty values 320 (e.g., a mean variance), a maximum value of a set of uncertainty values 320 (e.g., a maximum variance), or a single value of a set of uncertainty values 320 (e.g., a variance of a maximum predicted value). In such cases, a UE 115 may select (e.g., determine) a type of uncertainty value 320. For example, the UE 115 may select to indicate an uncertainty value 320 that is a maximum value of 16 variance values (e.g., for each of the 16 strongest predictions).

The UE 115 may then transmit an indication to a network entity 105 indicating that the uncertainty value 320 is a maximum value of the 16 variance values.

In some cases, a type of uncertainty value 320 may correspond to a type of mathematical model (e.g., an artificial intelligence model, a machine learning model) for determining predictions (e.g., sequences of predicted values). For example, a communication device such as a network entity 105 or a UE 115 may be configured with a quantity of different mathematical models (e.g., four different neural networks) for determining predictions. Each mathematical model of the quantity of different mathematical models may correspond to a type of uncertainty value 320. For example, a first mathematical model may generate or output one or more uncertainty values 320 of a first type (e.g., a mean variance), a second mathematical model may generate or output one or more uncertainty values 320 of a second type (e.g., a maximum variance), and so forth. In such cases, a communication device may indicate (e.g., implicitly) a type of a mathematical model based on indicating (e.g., explicitly) a type of uncertainty value 320, or vice versa. For example, a UE 115 may transmit an indication of a type of uncertainty value 320 to a network entity 105 and the network entity 105 may determine a type of mathematical model based on receiving the indication of the type of uncertainty value 320.

In some cases, a network entity 105 may configure the encoder 305. For example, the network entity 105 may determine a configuration for determining a quantity of bits 310 (e.g., for compression operations at the encoder 305). The network entity 105 may transmit an indication of the configuration to a UE 115 and the UE 115 may determine a quantity of bits 310 (e.g., to output via the encoder 305) based on the configuration. The configuration may indicate a mathematical model or an algorithm for the operation of the encoder 305. As described herein, encoder 305 may be capable of operating according to multiple mathematical models. In some cases, the network entity 105 may configure the encoder 305 by indicating which mathematical model of the multiple mathematical models the encoder 305 should operate according to.

A configuration for the encoder 305 may include mappings (e.g., associations) between quantities of bits 310 and uncertainty values 320. Accordingly, the encoder 305 may determine a quantity of bits 310 based on the mapping (e.g., based on one or more uncertainty values 320). For example, the encoder 305 may determine a quantity of the bits 310-a and a quantity of the bits 310-b based on the configuration (e.g., the mapping). A quantity of the bits 310-a may correspond to the uncertainty value 320-a and a quantity of the bits 310-b may correspond to the uncertainty value 320-b. In such cases, the quantity of bits 310-a may be lesser than the quantity of bits 310-b based on the uncertainty value 320-a being lesser than the uncertainty value 320-b.

In some cases, a UE 115 may configure the encoder 305 (e.g., the UE 115 may configure the encoder 305 independently of signaling received from a network entity 105). In such cases, a UE 115 may determine respective quantities of bits 310 based on a configuration (e.g., a pre-configuration, a setting for the UE 115). For example, the encoder 305 (e.g., the UE 115 including the encoder 305) may be configured (e.g., during manufacturing) to determine respective quantities of bits 310 according to a mathematical model or an algorithm. In such cases, a network entity 105 may perform one or more decoding operations based on the configuration of the encoder 305. For example, the network entity 105 may determine the configuration of the encoder 305 based on an indication received from a UE 115. In some other cases, a network entity 105 may implicitly determine a configuration of the encoder 305.

A configuration for the encoder 305 may be based on one or more ranges of uncertainty values 320 (e.g., ranges of standard deviations). In such cases, the configuration may specify a first quantity of bits 310 for a first range of uncertainty values 320, a second quantity of bits 310 for a second range of uncertainty values 320, and so forth. For example, a standard deviation, S, for a set of predictions 315 may be included in a range of standard deviations (e.g., S<2 decibel-milliwatts (dBm), 2 dBm≤S<6 dBm, 6 dBm≤S≤12 dBm, S>12 dBm), which may correspond to a range of bit quantities (e.g., 6 bits, 12 bits, 24 bits, 36 bits). In some cases, a UE 115 may transmit (e.g., to a network entity 105) an indication of a configuration for the encoder (e.g., a configuration for determining a bit width of an encoder 305 output). For example, the UE 115 may transmit an identifier (ID) that corresponds to a configuration for the encoder. Additionally, or alternatively, the UE 115 may transmit the output of the encoder 305 (e.g., the UE 115 may jointly transmit the output of the encoder 305 and the ID corresponding to the configuration).

A configuration for the encoder 305 may be based on a CSI report (e.g., a CSI report that includes one or more predictions). In such cases, the configuration for the encoder 305 may correspond to a CSI report setting. The report setting may specify (e.g., indicate) if CSI reports are periodic, semi-periodic, or aperiodic. For example, a first configuration my correspond to periodic CSI reports, a second configuration may correspond to semi-periodic CSI reports, and a third configuration may correspond to aperiodic CSI reports. In some cases, the configuration may be indicated by a MAC CE that activates CSI reports (e.g., a MAC CE that activates SP CSI reports). Additionally, or alternatively, the configuration may be triggered via DCI signaling. For example, the configuration may be based on aperiodic CSI trigger state configurations for aperiodic CSI reports.

FIG. 3B may illustrate an example of a block diagram 300-b that supports techniques for beam management in accordance with one or more aspects of the present disclosure. One or more aspects of the block diagram 300-b may be implemented by one or more aspects of the wireless communications system 100 or the wireless communications system 200. For example, the block diagram 300-b may include a decoder 325, which may be implemented by or otherwise controlled by a communication device such as a network entity 105 or a UE 115 as described with reference to FIGS. 1 and 2. For example, a network entity 105 may include a decoder 325. In some cases, the block diagram 300-b may include bits 310-c and bits 310-d, which may each be processed by the decoder 325. In some cases, the decoder 325 may receive bits 310 (e.g., as inputs), such as the bits 310-a or the bits 310-b, as described with reference to FIG. 3A. Additionally, or alternatively, the block diagram 300-b may include a set of predictions 315-c and a set of predictions 315-d, which may be associated with uncertainty values 320. Although FIG. 3B shows ranges of values as illustrative examples of uncertainty values 320, an uncertainty value 320 may be represented differently (e.g., determined differently) in accordance with examples as described herein in further detail.

The decoder 325 may have one or more inputs and one or more outputs. For example, the decoder 325 may receive information (e.g., bits 310-c, bits 310-d, which may be the same as bits 310-a and 310-b, respectively) via the one or more inputs, perform one or more operations to decompress the information (e.g., decode the information), and transmit the decoded information (e.g., bits 310-c, bits 310-d). For example, the decoder 325, may transmit the decoded information to one or more components of a network entity 105. In such cases, the network entity 105 may utilize the decoded information for beam management. For example, the network entity 105 may select a beam or a beam-pair based on the decoded information. As described herein, the decoder 325 may be a component of or may be otherwise associated with a network entity 105 or any other communication device. Accordingly, signaling and communications performed by the decoder 325 may be analogous with signaling and communications performed by a network entity 105.

In some cases, a network entity 105 (e.g., a decoder 325 of the network entity 105) may receive information from a UE 115 (e.g., bits 310-c, bits 310-d). The information may indicate one or more predictions, one or more uncertainty values 320, or both. For example, the network entity (e.g., the decoder 325 of the network entity 105) may receive a CSI report or a MAC CE from a UE 115 and the CSI report or the MAC CE may include one or more predictions. In such cases, the CSI report or the MAC CE may include bits 310 (e.g., bits 310-c, bits 310-d). The decoder 325 may decode bits 310-c and bits 310-d and may output the bits 310-c and the bits 310-d. The bits 310-c and the bits 310-d may indicate the one or more predictions (e.g., a sequence of values corresponding to a predicted RSRP). Additionally, or alternatively, a quantity of the bits 310-c and a quantity of the bits 310-d may be based on an uncertainty value 320. For example, a quantity of the bits 310-c may be based on an uncertainty value 320-c and a quantity of the bits 310-d may be based on an uncertainty value 320-d.

In some cases, a network entity 105 may configure the decoder 325. For example, the network entity 105 may determine a configuration for performing decoding operations at the decoder 325. In some cases, the configuration for the decoder 325 may be based on the configuration of the encoder 305. The decoder 325 may determine a quantity of bits 310 (e.g., to output) based on the configuration. In some cases, the configuration may be based on a mathematical model or an algorithm. In some cases, a UE 115 may configure the decoder 325.

A configuration for the decoder 325 may include mappings between quantities of bits 310 and uncertainty values 320. In such cases, the decoder 325 may determine and output a quantity of the bits 310-c and a quantity of the bits 310-d based on the configuration. In some cases, the decoder 325 may determine an uncertainty value 320 based on a quantity of bits 310. For example, a quantity of the bits 310-c may correspond to the uncertainty value 320-c and a quantity of the bits 310-d may correspond to the uncertainty value 320-d. In such cases, the quantity of bits 310-c may be lesser than the quantity of bits 310-d based on the uncertainty value 320-c being lesser than the uncertainty value 320-d.

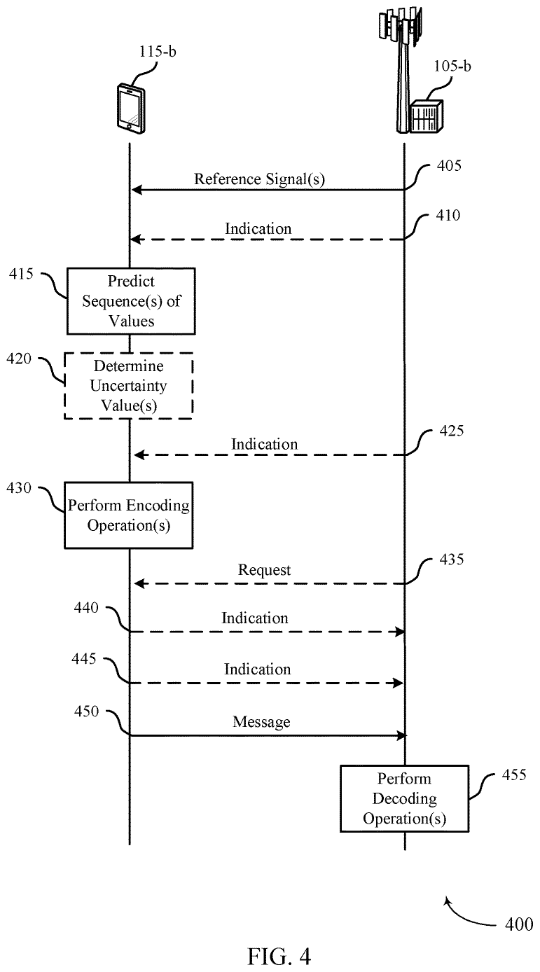

FIG. 4 illustrates an example of a process flow 400 that supports techniques for beam management in accordance with one or more aspects of the present disclosure. In some cases, the process flow 400 may implement aspects of the wireless communications system 100, the wireless communications system 200, and the block diagrams 300. For example, the process flow 400 may include a UE 115-b, which may be an example of corresponding UEs 115 as described with reference to FIGS. 1 and 2. Additionally, or alternatively, the process flow 400 may include a network entity 105-b, which may be an example of corresponding network entities 105 as described with reference to FIGS. 1 and 2. In some cases, the UE 115-b may perform variable bit-width encoding operations and the network entity 105-b may perform variable bit-width decoding operations, as described with reference to FIGS. 3A and 3B, which may improve utilization of communication resources.

In the following description of the process flow 400, the operations between the network entity 105-b and the UE 115-b may be performed in a different order than the order shown. Some operations may also be left out of the process flow 400, or other operations may be added to the process flow 400. Further, although some operations or communications may be shown to occur at different times for discussion purposes, these operations may occur at the same time. Additionally, or alternatively, although the network entity 105-b and the UE 115-b are shown performing a number of the operations of process flow 400, any wireless device may perform the operations shown.

At 405, the network entity 105-b may transmit multiple reference signals via a first plurality of beams. The network entity 105-b may multicast, broadcast, groupcast, or unicast the multiple reference signals. In some cases, the multiple reference signals may not be transmitted directly to the UE 115-b. For example, the network entity 105-b may broadcast the multiple reference signals over a geographic area. In some cases, the network entity 105-b may transmit each reference signal using a different beam. Accordingly, transmitting the multiple reference signals may enable the network entity 105-b and the UE 115-b to determine one or more preferred (e.g., optimal) beams for communications. In some cases, the network entity 105-b may transmit the multiple beams as part of a beam management procedure.

At 410, the UE 115-b may receive, from the network entity 105-b, an indication of a configuration for determining one or more uncertainty values. For example, the UE 115-b may perform one or more operations to predict sequences of values. In such cases, the configuration may be for determining an uncertainty value for a subset of the sequences of predicted values. Additionally, or alternatively, the UE 115-b may determine the uncertainty value based on the configuration. In some cases, each sequence of predicted values may be for a parameter for a reference signal. For example, the UE 115-b may predict a sequence of values that indicates a RSRP of a reference signal (e.g., a reference signal transmitted by the network entity 105-b at 405).

At 415, the UE 115-b may predict, for each beam of multiple beams, a sequence of values for at least one parameter. In some cases, the at least one parameter may include one or more RSRPs, one or more SINRs, or both. In some cases, each beam of the multiple beams may correspond to a respective beam-pair of multiple beam-pairs for communications between the UE 115-b and the network entity 105-b. As described herein, the sequence of values may indicate (e.g., represent, be an example of) a value of a parameter. For example, the sequence of values may indicate an RSRP for a beam (e.g., a beam-pair).

At 420, the UE 115-b may determine the uncertainty value for the at least the subset of the sequences of predicted values. For example, the UE 115-b may determine an uncertainty value for a single sequence of predicted values. In some other cases, the UE 115-b may determine an uncertainty value for a set of sequences of predicted values. In some cases, the uncertainty value may be based on a variation of the sequences of predicted values. For example, the UE 115-b may predict multiple sequences of values. The UE 115-b may determine a variation (e.g., a range, a standard deviation) of the sequences of predicted values and determine an uncertainty for the multiple predictions based on the variation. For example, a first subset of sequences of predicted values with a relatively high variation may a relatively high uncertainty when compared to a second subset of sequences of predicted values with a relatively low variation.

At 425, the UE 115-b may receive, from the network entity 105-b, an indication of a configuration for determining the quantity of bits based on the uncertainty value. The configuration may indicate a mapping between one or more ranges of uncertainty values and respective quantities of bits. For example, the configuration may indicate that a range of uncertainty values corresponds to a quantity of bits. In some cases, the UE 115-b may receive, from the network entity 105-b, a CSI report configuration including the indication, a MAC CE that activates a CSI report including the indication, or DCI that activates the CSI report including the indication where the CSI report includes the bits of the encoded sequences of predicted values.

At 430, the UE 115-b may perform respective encoding operations on at least a subset of the sequences of predicted values for the at least one parameter for at least a subset of the multiple beams, where a quantity of bits of the encoded sequences of predicted values generated by performing the respective encoding operations is based on an uncertainty value for the sequences of predicted values. For example, multiple sequences of predicted values may be input (e.g., by the UE 115-b) to an encoder of the UE 115-b and the encoder may output a quantity of bits based on an uncertainty for the sequence of predicted values.

At 435, the UE 115-b may receive a request from the network entity 105-b to transmit the message based on a ranking of the sequences of predicted values, where the UE 115-b determines the uncertainty value for the at least the subset of the sequences of predicted values based on a function of respective variance values of the at least the subset of the sequences of predicted values. In some cases, the UE 115-b may receive a request from the network entity 105-b to transmit the message based on a ranking of the sequences of predicted values, where the UE 115-b determines the uncertainty value for the at least the subset of the sequences of predicted values based on a variance value of a sequence of predicted values of the subset of the sequences of predicted values. In some cases, the sequence of predicted values may be selected from the subset of the sequences of predicted values based on respective signal powers for the subset of the sequences of predicted values.

At 440, the UE 115-b may transmit, to the network entity 105-b, an indication of a configuration for determining the uncertainty value. In some cases, the configuration for determining the uncertainty value may correspond to a mathematical model of multiple mathematical models for predicting the sequence of values for the at least one parameter. For example, based on the configuration, the UE 115-b may determine the uncertainty value using a machine learning model, or may otherwise determine the uncertainty value using any other type of mathematical model (e.g., a mathematical model that implements artificial intelligence).

At 445, the UE 115-b may transmit, to the network entity 105-b, an indication of the quantity of bits of the at least the subset of encoded sequences of predicted values. In some cases, transmitting the indication of the quantity of bits corresponds to a mathematical model of multiple mathematical models for predicting the sequence of values for the at least one parameter. For example, the mathematical model may output a quantity of bits and the UE 115-b may transmit an indication to the network entity 105-b that indicates the quantity of bits.

At 450, the UE 115-b may transmit, to the network entity 105-b, a message including the bits of the encoded sequences of predicted values. In some cases, the UE 115-b may transmit the message including the bits of the at least the subset of encoded sequences of predicted values, where the bits correspond to a quantity of the at least the subset of the sequences of predicted values having respective rankings that satisfy a threshold. In some cases, the message may be included in a CSI report. For example, at 450, the UE 115-b may transmit, to the network entity 105-b, a CSI report. The CSI report may include a first portion and a second portion. The first portion may include an indication of the quantity of bits and the second portion may include the bits of the at least the subset of encoded sequences of predicted values.

At 455, the network entity 105-b may perform one or more decoding operations on the set of bits based on the uncertainty value, where the network entity 105-b identifies the sequences of predicted values based on performing the one or more decoding operations. In some cases, the network entity 105-b may perform the one or more decoding operations based on a configuration for determining the uncertainty value based on the total quantity of bits in the set of bits. In some cases, the network entity 105-b may determine the uncertainty value for the sequences of predicted values based on the total quantity of bits in the set of bits.

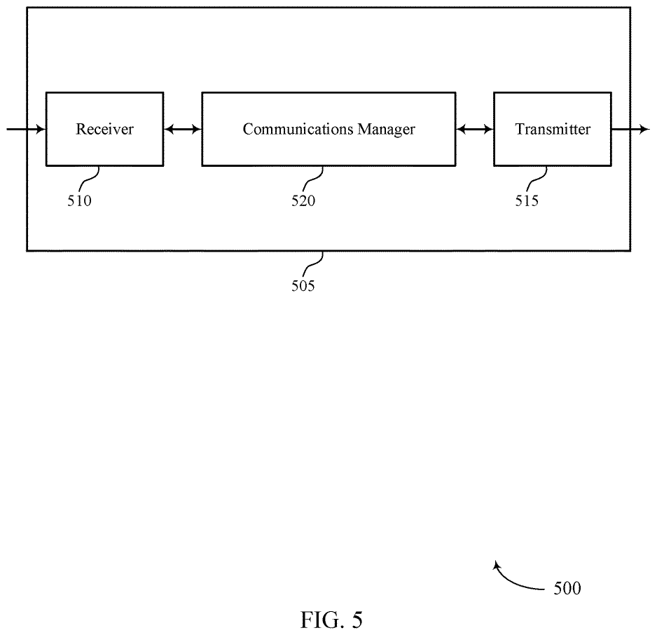

FIG. 5 illustrates a block diagram 500 of a device 505 that supports techniques for beam management in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for beam management). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for beam management). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for beam management as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for predicting, for each of a set of multiple beams, a sequence of values for at least one parameter. The communications manager 520 may be configured as or otherwise support a means for performing respective encoding operations on at least a subset of the sequences of predicted values for the at least one parameter for at least a subset of the set of multiple beams, where a quantity of bits of the encoded sequences of predicted values generated by performing the respective encoding operations is based on an uncertainty value for the sequences of predicted values. The communications manager 520 may be configured as or otherwise support a means for transmitting, to a network entity, a message including the bits of the encoded sequences of predicted values.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing overhead, reduced power consumption, and more efficient utilization of communication resources. For example, the device 505 may support variable bit-width signaling, which may include communicating a configurable quantity of bits based on an uncertainty value associated with the bits. Accordingly, information (e.g., predictions) having lower uncertainty values may be communicated (e.g., by the device 505) using a lesser quantity of bits than information having higher uncertainty values, which may reduce processing overhead, reduce power consumption, and improve utilization of communication resources.

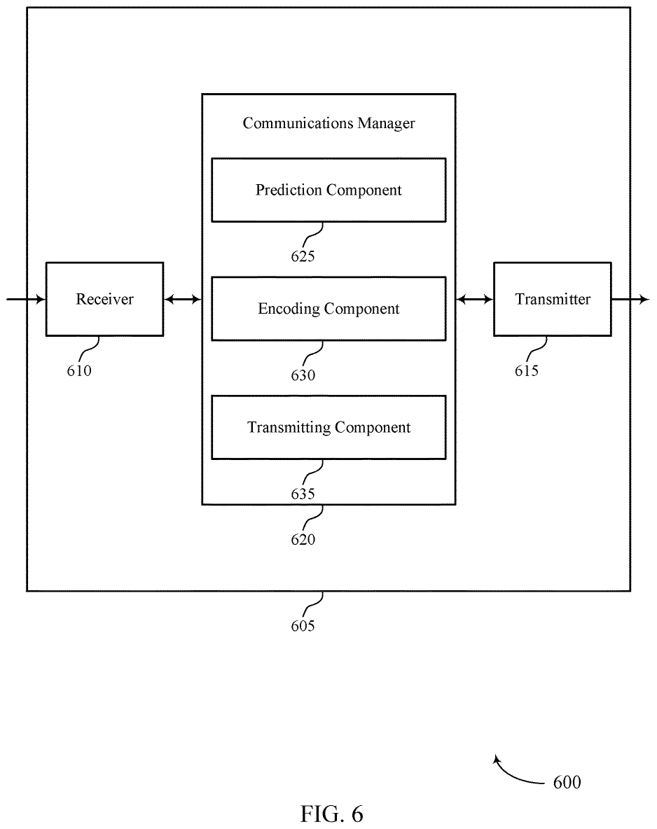

FIG. 6 illustrates a block diagram 600 of a device 605 that supports techniques for beam management in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for beam management). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for beam management). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for beam management as described herein. For example, the communications manager 620 may include a prediction component 625, an encoding component 630, a transmitting component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The prediction component 625 may be configured as or otherwise support a means for predicting, for each of a set of multiple beams, a sequence of values for at least one parameter. The encoding component 630 may be configured as or otherwise support a means for performing respective encoding operations on at least a subset of the sequences of predicted values for the at least one parameter for at least a subset of the set of multiple beams, where a quantity of bits of the encoded sequences of predicted values generated by performing the respective encoding operations is based on an uncertainty value for the sequences of predicted values. The transmitting component 635 may be configured as or otherwise support a means for transmitting, to a network entity, a message including the bits of the encoded sequences of predicted values.

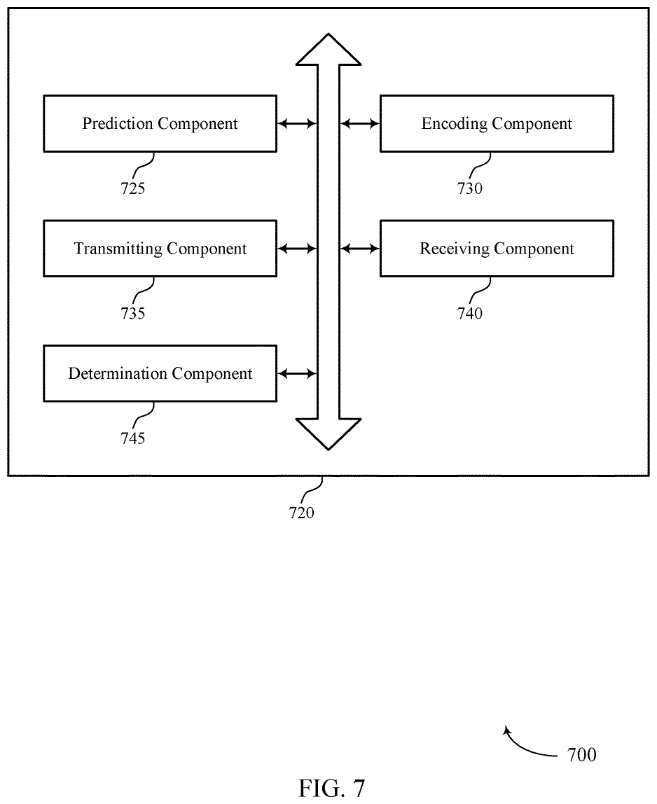

FIG. 7 illustrates a block diagram 700 of a communications manager 720 that supports techniques for beam management in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for beam management as described herein. For example, the communications manager 720 may include a prediction component 725, an encoding component 730, a transmitting component 735, a receiving component 740, a determination component 745, or any combination thereof. Each of these components may communicate, directly or indirectly, with one another (e.g., via one or more buses).

The communications manager 720 may support wireless communication at a UE in accordance with examples as disclosed herein. The prediction component 725 may be configured as or otherwise support a means for predicting, for each of a set of multiple beams, a sequence of values for at least one parameter. The encoding component 730 may be configured as or otherwise support a means for performing respective encoding operations on at least a subset of the sequences of predicted values for the at least one parameter for at least a subset of the set of multiple beams, where a quantity of bits of the encoded sequences of predicted values generated by performing the respective encoding operations is based on an uncertainty value for the sequences of predicted values. The transmitting component 735 may be configured as or otherwise support a means for transmitting, to a network entity, a message including the bits of the encoded sequences of predicted values.

In some examples, the receiving component 740 may be configured as or otherwise support a means for receiving a request from the network entity to transmit the message based on a ranking of the sequences of predicted values, where the UE determines the uncertainty value for the at least the subset of the sequences of predicted values based at least in part on a function of respective variance values of the at least the subset of the sequences of predicted values.

In some examples, the receiving component 740 may be configured as or otherwise support a means for receiving a request from the network entity to transmit the message based on a ranking of the sequences of predicted values, where the UE determines the uncertainty value for the at least the subset of the sequences of predicted values based on a variance value of a sequence of predicted values of the subset of the sequences of predicted values, the sequence of predicted values selected from the subset of the sequences of predicted values based on respective signal powers associated with the subset of the sequences of predicted values.

In some examples, to support transmitting the message to the network entity, the transmitting component 735 may be configured as or otherwise support a means for transmitting the message including the bits of the at least the subset of encoded sequences of predicted values, where the bits correspond to a quantity of the at least the subset of the sequences of predicted values having respective rankings that satisfy a threshold.

In some examples, the receiving component 740 may be configured as or otherwise support a means for receiving, from the network entity, an indication of a configuration for determining the uncertainty value for the at least the subset of the sequences of predicted values, where the UE determines the uncertainty value based on the configuration.

In some examples, the determination component 745 may be configured as or otherwise support a means for determining the uncertainty value for the at least the subset of the sequences of predicted values. In some examples, the transmitting component 735 may be configured as or otherwise support a means for transmitting, to the network entity, an indication of a configuration for determining the uncertainty value.

In some examples, the configuration for determining the uncertainty value corresponds to a mathematical model of a set of multiple mathematical models for predicting the sequence of values for the at least one parameter.

In some examples, the receiving component 740 may be configured as or otherwise support a means for receiving, from the network entity, an indication of a configuration for determining the quantity of bits based on the uncertainty value, the configuration indicating a mapping between one or more ranges of uncertainty values and respective quantities of bits.

In some examples, to support receiving the indication of the configuration, the receiving component 740 may be configured as or otherwise support a means for receiving, from the network entity, a channel state information report configuration including the indication, a medium access control control element that activates a channel state information report including the indication, or downlink control information that activates the channel state information report including the indication where the channel state information report includes the bits of the encoded sequences of predicted values.

In some examples, the transmitting component 735 may be configured as or otherwise support a means for transmitting, to the network entity, an indication of the quantity of bits of the at least the subset of encoded sequences of predicted values.

In some examples, transmitting the indication of the quantity of bits corresponds to a mathematical model of a set of multiple mathematical models for predicting the sequence of values for the at least one parameter.

In some examples, the transmitting component 735 may be configured as or otherwise support a means for transmitting, to the network entity, a channel state information report including a first portion and a second portion, the first portion including an indication of the quantity of bits and the second portion including the bits of the at least the subset of encoded sequences of predicted values.

In some examples, the at least one parameter includes one or more reference signal received powers, one or more signal-to-interference-plus-noise ratios, or both.

In some examples, to support transmitting the message to the network entity, the transmitting component 735 may be configured as or otherwise support a means for transmitting a channel state information report or a medium access control control element to the network entity, where the channel state information report or the medium access control control element includes the bits of the encoded sequences of predicted values.

In some examples, each beam of the set of multiple beams corresponds to a respective beam-pair of a set of multiple beam-pairs for communications between the UE and the network entity.

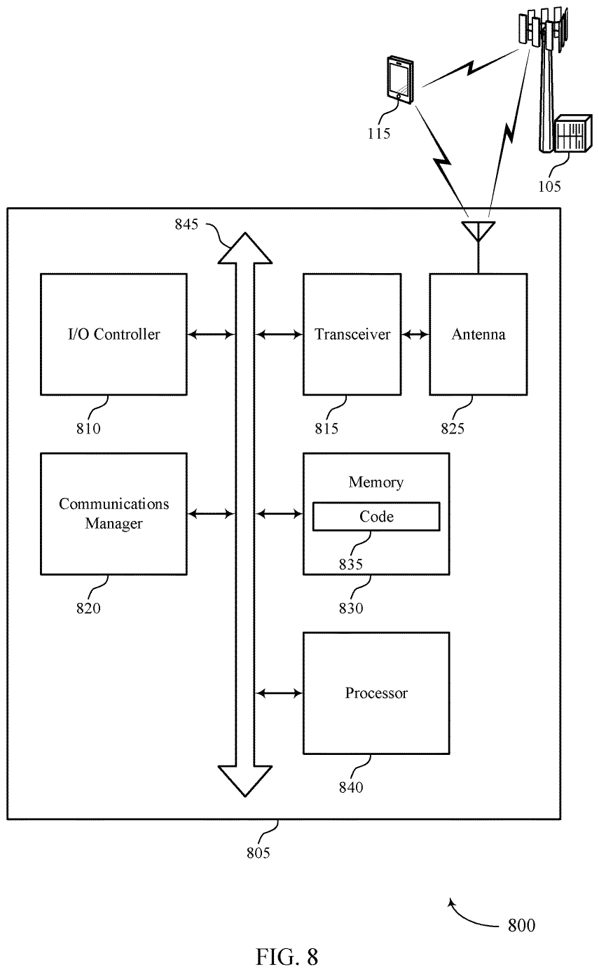

FIG. 8 illustrates a diagram of a system 800 including a device 805 that supports techniques for beam management in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for beam management). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for predicting, for each of a set of multiple beams, a sequence of values for at least one parameter. The communications manager 820 may be configured as or otherwise support a means for performing respective encoding operations on at least a subset of the sequences of predicted values for the at least one parameter for at least a subset of the set of multiple beams, where a quantity of bits of the encoded sequences of predicted values generated by performing the respective encoding operations is based on an uncertainty value for the sequences of predicted values. The communications manager 820 may be configured as or otherwise support a means for transmitting, to a network entity, a message including the bits of the encoded sequences of predicted values.

By including or configuring the communications manager 820 in accordance with examples as described herein, the device 805 may support techniques for reduced latency, improved coordination between devices, and longer battery live. For example, the device 805 may support variable bit-width signaling, which may include communicating a configurable quantity of bits based on an uncertainty value associated with the bits. Accordingly, information (e.g., predictions) having lower uncertainty values may be communicated (e.g., by the device 805) using a lesser quantity of bits than information having higher uncertainty values, which may reduce latency and reduce power consumption. Additionally, or alternatively, the device 805 may communicate information associated with variable bit-width signaling to other devices, which may improve coordination between devices. For example, the device 805 may indicate a quantity of bits included in communications, which may enable other devices to more effectively decode the communications.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for beam management as described herein, or the processor 840 and the memory 830 may be otherwise configured to perform or support such operations.

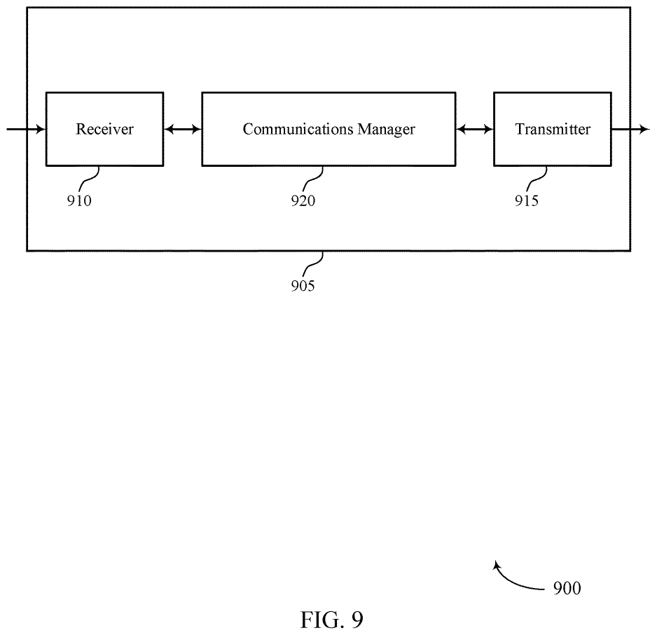

FIG. 9 illustrates a block diagram 900 of a device 905 that supports techniques for beam management in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of techniques for beam management as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for transmitting a set of multiple reference signals via a first set of multiple beams. The communications manager 920 may be configured as or otherwise support a means for receiving, from a UE, a message including a set of bits based on transmitting the set of multiple reference signals, where a total quantity of bits in the set of bits is based on an uncertainty value associated with sequences of predicted values for at least one parameter, the sequences of predicted values associated with a second set of multiple beams. The communications manager 920 may be configured as or otherwise support a means for performing one or more decoding operations on the set of bits based on the uncertainty value, where the network entity identifies the sequences of predicted values based on performing the one or more decoding operations.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing overhead, reduced power consumption, and more efficient utilization of communication resources. For example, the device 905 may support variable bit-width signaling, which may include communicating a configurable quantity of bits based on an uncertainty value associated with the bits. Accordingly, information (e.g., predictions) having lower uncertainty values may be communicated (e.g., by the device 905) using a lesser quantity of bits than information having higher uncertainty values, which may reduce processing overhead, reduce power consumption, and improve utilization of communication resources.

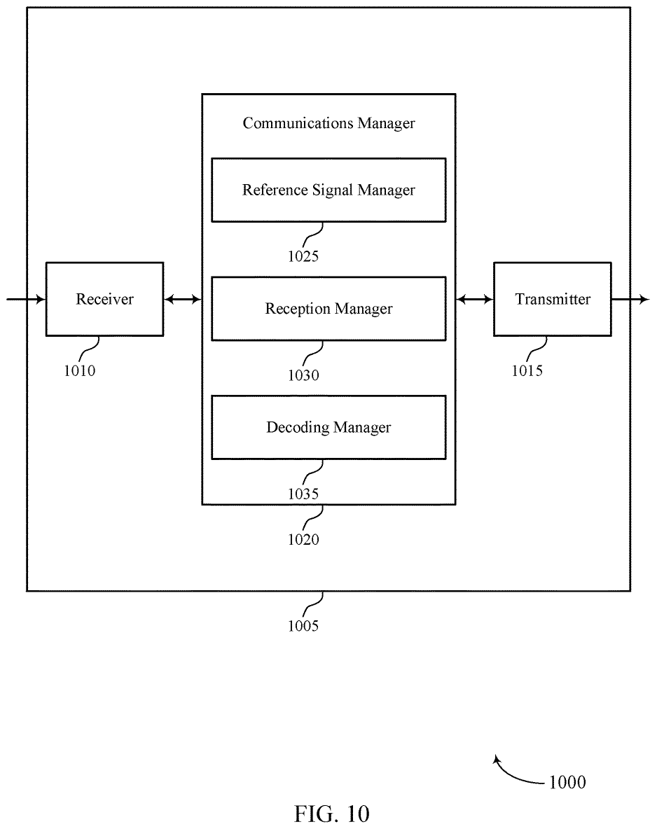

FIG. 10 illustrates a block diagram 1000 of a device 1005 that supports techniques for beam management in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas.

Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for beam management as described herein. For example, the communications manager 1020 may include a reference signal manager 1025, a reception manager 1030, a decoding manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The reference signal manager 1025 may be configured as or otherwise support a means for transmitting a set of multiple reference signals via a first set of multiple beams. The reception manager 1030 may be configured as or otherwise support a means for receiving, from a UE, a message including a set of bits based on transmitting the set of multiple reference signals, where a total quantity of bits in the set of bits is based on an uncertainty value associated with sequences of predicted values for at least one parameter, the sequences of predicted values associated with a second set of multiple beams. The decoding manager 1035 may be configured as or otherwise support a means for performing one or more decoding operations on the set of bits based on the uncertainty value, where the network entity identifies the sequences of predicted values based on performing the one or more decoding operations.

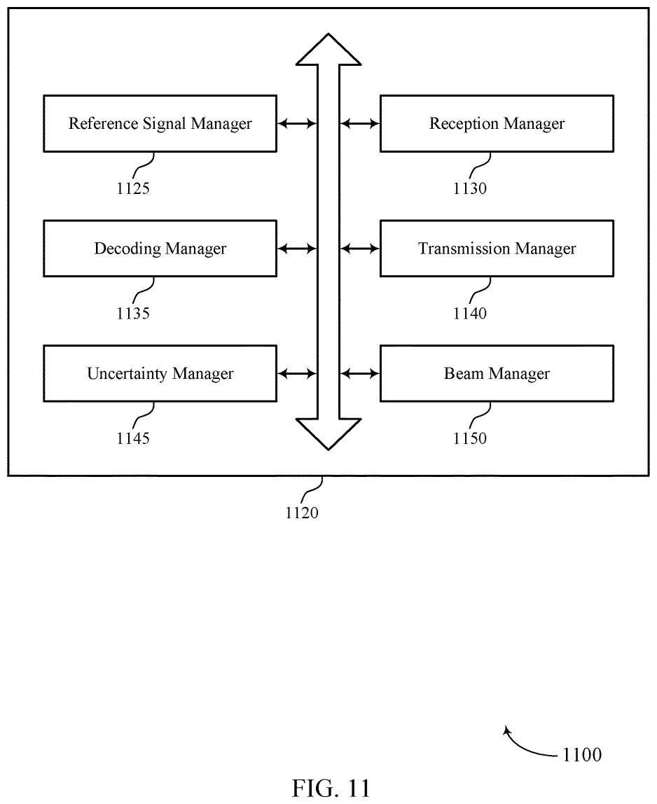

FIG. 11 illustrates a block diagram 1100 of a communications manager 1120 that supports techniques for beam management in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for beam management as described herein. For example, the communications manager 1120 may include a reference signal manager 1125, a reception manager 1130, a decoding manager 1135, a transmission manager 1140, an uncertainty manager 1145, a beam manager 1150, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The reference signal manager 1125 may be configured as or otherwise support a means for transmitting a set of multiple reference signals via a first set of multiple beams. The reception manager 1130 may be configured as or otherwise support a means for receiving, from a UE, a message including a set of bits based on transmitting the set of multiple reference signals, where a total quantity of bits in the set of bits is based on an uncertainty value associated with sequences of predicted values for at least one parameter, the sequences of predicted values associated with a second set of multiple beams. The decoding manager 1135 may be configured as or otherwise support a means for performing one or more decoding operations on the set of bits based on the uncertainty value, where the network entity identifies the sequences of predicted values based on performing the one or more decoding operations.

In some examples, the transmission manager 1140 may be configured as or otherwise support a means for transmitting, to the UE, an indication of a configuration for determining the uncertainty value for the sequences of predicted values.

In some examples, to support performing the one or more decoding operations, the decoding manager 1135 may be configured as or otherwise support a means for performing the one or more decoding operations based on a configuration for determining the uncertainty value based on the total quantity of bits in the set of bits.

In some examples, the uncertainty manager 1145 may be configured as or otherwise support a means for determining the uncertainty value associated with the sequences of predicted values based on the total quantity of bits in the set of bits.

In some examples, the transmission manager 1140 may be configured as or otherwise support a means for transmitting a request to the UE to transmit the message based on a ranking of the sequences of predicted values, where the uncertainty value for the sequences of predicted values is based on an average of a set of uncertainty values for the sequences of predicted values.

In some examples, the transmission manager 1140 may be configured as or otherwise support a means for transmitting a request to the UE to transmit the message based on a ranking of the sequences of predicted values, where the uncertainty value for the sequences of predicted values is based on a maximum uncertainty value of a set of uncertainty values for the sequences of predicted values.

In some examples, the transmission manager 1140 may be configured as or otherwise support a means for transmitting a request to the UE to transmit the message based on a ranking of the sequences of predicted values, where the uncertainty value for the sequences of predicted values is based on a comparison of respective values of the at least one parameter, each respective value corresponding to a respective sequence of values.

In some examples, to support receiving the message from the UE, the reception manager 1130 may be configured as or otherwise support a means for receiving the message including the bits, where the bits correspond to a quantity of the sequences of predicted values having respective rankings that satisfy a threshold.

In some examples, the reception manager 1130 may be configured as or otherwise support a means for receiving, from the UE, an indication of a configuration for determining the uncertainty value.

In some examples, the configuration for determining the uncertainty value corresponds to a mathematical model of a set of multiple mathematical models for predicting the sequences of values for the at least one parameter.

In some examples, the transmission manager 1140 may be configured as or otherwise support a means for transmitting, to the UE, an indication of a configuration for determining the total quantity of bits based on the uncertainty value, the configuration indicating a mapping between one or more ranges of uncertainty values and respective total quantities of bits.

In some examples, to support transmitting the indication of the configuration, the transmission manager 1140 may be configured as or otherwise support a means for transmitting, to the UE, a channel state information report configuration including the indication, a medium access control control element that activates a channel state information report including the indication, or downlink control information that activates the channel state information report including the indication, where the channel state information report includes the set of bits.

In some examples, each beam of the first set of multiple beams corresponds to a respective beam-pair of a first set of multiple beam-pairs for communications between the network entity and the UE. In some examples, each beam of the second set of multiple beams corresponds to a respective beam-pair of a second set of multiple beam-pairs for the communications between the network entity and the UE.

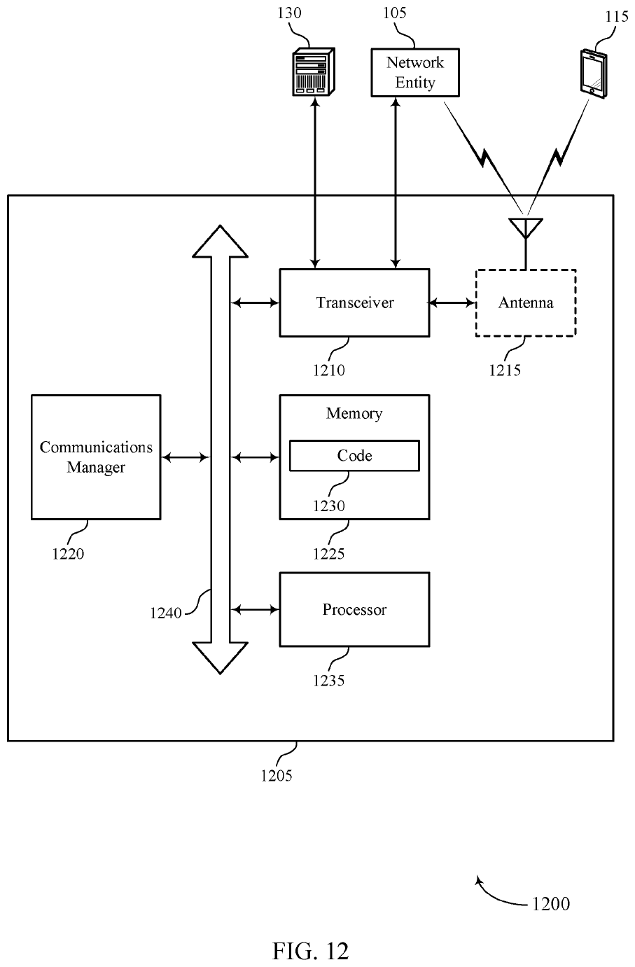

FIG. 12 illustrates a diagram of a system 1200 including a device 1205 that supports techniques for beam management in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting techniques for beam management). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for transmitting a set of multiple reference signals via a first set of multiple beams. The communications manager 1220 may be configured as or otherwise support a means for receiving, from a UE, a message including a set of bits based on transmitting the set of multiple reference signals, where a total quantity of bits in the set of bits is based on an uncertainty value associated with sequences of predicted values for at least one parameter, the sequences of predicted values associated with a second set of multiple beams. The communications manager 1220 may be configured as or otherwise support a means for performing one or more decoding operations on the set of bits based on the uncertainty value, where the network entity identifies the sequences of predicted values based on performing the one or more decoding operations.

By including or configuring the communications manager 1220 in accordance with examples as described herein, the device 1205 may support techniques for reduced latency, improved coordination between devices, and longer battery live.

For example, the device 1205 may support variable bit-width signaling, which may include communicating a configurable quantity of bits based on an uncertainty value associated with the bits. Accordingly, information (e.g., predictions) having lower uncertainty values may be communicated (e.g., by the device 1205) using a lesser quantity of bits than information having higher uncertainty values, which may reduce latency and reduce power consumption. Additionally, or alternatively, the device 1205 may communicate information associated with variable bit-width signaling to other devices, which may improve coordination between devices. For example, the device 1205 may indicate a quantity of bits included in communications, which may enable other devices to more effectively decode the communications.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of techniques for beam management as described herein, or the processor 1235 and the memory 1225 may be otherwise configured to perform or support such operations.

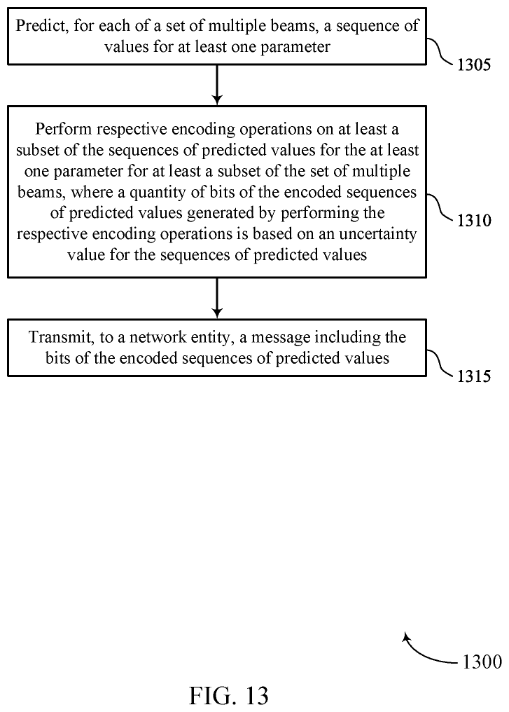

FIG. 13 illustrates a flowchart illustrating a method 1300 that supports techniques for beam management in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include predicting, for each of a set of multiple beams, a sequence of values for at least one parameter. The operations of 1305 may be performed in accordance with examples as disclosed herein. In some examples, aspects of the operations of 1305 may be performed by a prediction component 725 as described with reference to FIG. 7.

At 1310, the method may include performing respective encoding operations on at least a subset of the sequences of predicted values for the at least one parameter for at least a subset of the set of multiple beams, where a quantity of bits of the encoded sequences of predicted values generated by performing the respective encoding operations is based on an uncertainty value for the sequences of predicted values. The operations of 1310 may be performed in accordance with examples as disclosed herein. In some examples, aspects of the operations of 1310 may be performed by an encoding component 730 as described with reference to FIG. 7.

At 1315, the method may include transmitting, to a network entity, a message including the bits of the encoded sequences of predicted values. The operations of 1315 may be performed in accordance with examples as disclosed herein. In some examples, aspects of the operations of 1315 may be performed by a transmitting component 735 as described with reference to FIG. 7.

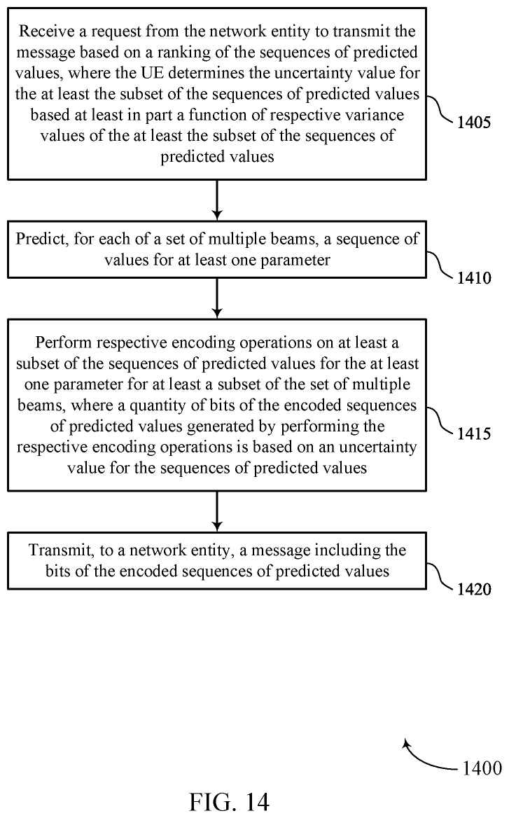

FIG. 14 illustrates a flowchart illustrating a method 1400 that supports techniques for beam management in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a request from the network entity to transmit the message based on a ranking of the sequences of predicted values, where the UE determines the uncertainty value for the at least the subset of the sequences of predicted values based at least in part on a function of respective variance values of the at least the subset of the sequences of predicted values. The operations of 1405 may be performed in accordance with examples as disclosed herein. In some examples, aspects of the operations of 1405 may be performed by a receiving component 740 as described with reference to FIG. 7.

At 1410, the method may include predicting, for each of a set of multiple beams, a sequence of values for at least one parameter. The operations of 1410 may be performed in accordance with examples as disclosed herein. In some examples, aspects of the operations of 1410 may be performed by a prediction component 725 as described with reference to FIG. 7.

At 1415, the method may include performing respective encoding operations on at least a subset of the sequences of predicted values for the at least one parameter for at least a subset of the set of multiple beams, where a quantity of bits of the encoded sequences of predicted values generated by performing the respective encoding operations is based on an uncertainty value for the sequences of predicted values. The operations of 1415 may be performed in accordance with examples as disclosed herein. In some examples, aspects of the operations of 1415 may be performed by an encoding component 730 as described with reference to FIG. 7.

At 1420, the method may include transmitting, to a network entity, a message including the bits of the encoded sequences of predicted values. The operations of 1420 may be performed in accordance with examples as disclosed herein. In some examples, aspects of the operations of 1420 may be performed by a transmitting component 735 as described with reference to FIG. 7.

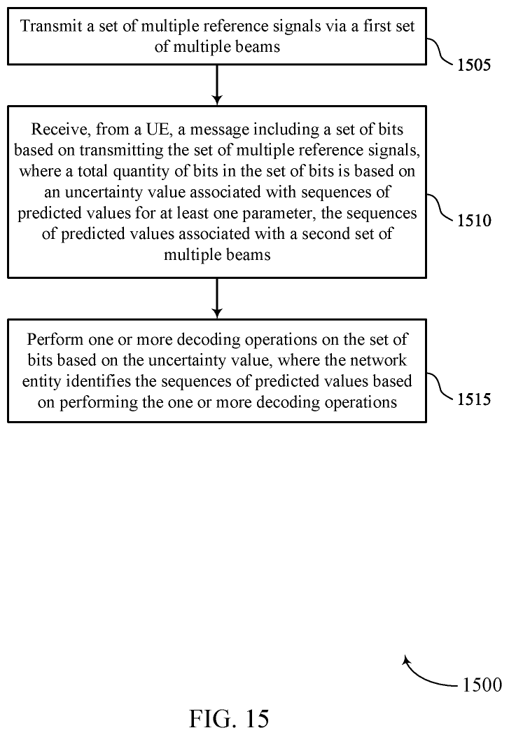

FIG. 15 illustrates a flowchart illustrating a method 1500 that supports techniques for beam management in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting a set of multiple reference signals via a first set of multiple beams. The operations of 1505 may be performed in accordance with examples as disclosed herein. In some examples, aspects of the operations of 1505 may be performed by a reference signal manager 1125 as described with reference to FIG. 11.

At 1510, the method may include receiving, from a UE, a message including a set of bits based on transmitting the set of multiple reference signals, where a total quantity of bits in the set of bits is based on an uncertainty value associated with sequences of predicted values for at least one parameter, the sequences of predicted values associated with a second set of multiple beams. The operations of 1510 may be performed in accordance with examples as disclosed herein. In some examples, aspects of the operations of 1510 may be performed by a reception manager 1130 as described with reference to FIG. 11.

At 1515, the method may include performing one or more decoding operations on the set of bits based on the uncertainty value, where the network entity identifies the sequences of predicted values based on performing the one or more decoding operations. The operations of 1515 may be performed in accordance with examples as disclosed herein. In some examples, aspects of the operations of 1515 may be performed by a decoding manager 1135 as described with reference to FIG. 11.

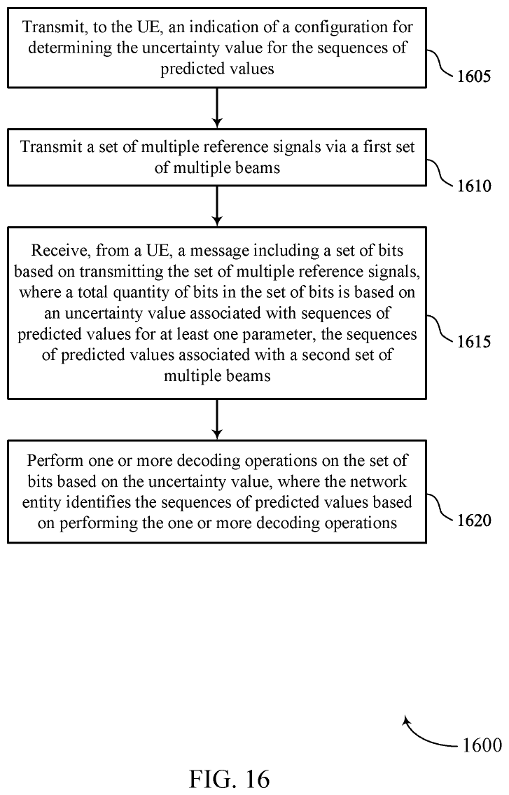

FIG. 16 illustrates a flowchart illustrating a method 1600 that supports techniques for beam management in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to the UE, an indication of a configuration for determining the uncertainty value for the sequences of predicted values. The operations of 1605 may be performed in accordance with examples as disclosed herein. In some examples, aspects of the operations of 1605 may be performed by a transmission manager 1140 as described with reference to FIG. 11.

At 1610, the method may include transmitting a set of multiple reference signals via a first set of multiple beams. The operations of 1610 may be performed in accordance with examples as disclosed herein. In some examples, aspects of the operations of 1610 may be performed by a reference signal manager 1125 as described with reference to FIG. 11.

At 1615, the method may include receiving, from a UE, a message including a set of bits based on transmitting the set of multiple reference signals, where a total quantity of bits in the set of bits is based on an uncertainty value associated with sequences of predicted values for at least one parameter, the sequences of predicted values associated with a second set of multiple beams. The operations of 1615 may be performed in accordance with examples as disclosed herein. In some examples, aspects of the operations of 1615 may be performed by a reception manager 1130 as described with reference to FIG. 11.

At 1620, the method may include performing one or more decoding operations on the set of bits based on the uncertainty value, where the network entity identifies the sequences of predicted values based on performing the one or more decoding operations. The operations of 1620 may be performed in accordance with examples as disclosed herein. In some examples, aspects of the operations of 1620 may be performed by a decoding manager 1135 as described with reference to FIG. 11.

The following provides an overview of aspects of the present disclosure:
Aspect 1: A method for wireless communication at a UE, comprising: predicting, for each of a plurality of beams, a sequence of values for at least one parameter; performing respective encoding operations on at least a subset of the sequences of predicted values for the at least one parameter for at least a subset of the plurality of beams, wherein a quantity of bits of the encoded sequences of predicted values generated by performing the respective encoding operations is based at least in part on an uncertainty value for the sequences of predicted values; and transmitting, to a network entity, a message comprising the bits of the encoded sequences of predicted values.
Aspect 2: The method of aspect 1, further comprising: receiving a request from the network entity to transmit the message based at least in part on a ranking of the sequences of predicted values, wherein the UE determines the uncertainty value for the at least the subset of the sequences of predicted values based at least in part on a function of respective variance values of the at least the subset of the sequences of predicted values.
Aspect 3: The method of aspect 1, further comprising: receiving a request from the network entity to transmit the message based at least in part on a ranking of the sequences of predicted values, wherein the UE determines the uncertainty value for the at least the subset of the sequences of predicted values based at least in part on a variance value of a sequence of predicted values of the subset of the sequences of predicted values, the sequence of predicted values selected from the subset of the sequences of predicted values based at least in part on respective signal powers associated with the subset of the sequences of predicted values.
Aspect 4: The method of any of aspects 1 through 3, wherein transmitting the message to the network entity further comprises: transmitting the message comprising the bits of the at least the subset of encoded sequences of predicted values, wherein the bits correspond to a quantity of the at least the subset of the sequences of predicted values having respective rankings that satisfy a threshold.
Aspect 5: The method of any of aspects 1 through 4, further comprising: receiving, from the network entity, an indication of a configuration for determining the uncertainty value for the at least the subset of the sequences of predicted values, where the UE determines the uncertainty value based at least in part on the configuration.
Aspect 6: The method of any of aspects 1 through 4, further comprising: determining the uncertainty value for the at least the subset of the sequences of predicted values; and transmitting, to the network entity, an indication of a configuration for determining the uncertainty value.
Aspect 7: The method of aspect 6, wherein the configuration for determining the uncertainty value corresponds to a mathematical model of a plurality of mathematical models for predicting the sequence of values for the at least one parameter.
Aspect 8: The method of any of aspects 1 through 5, further comprising: receiving, from the network entity, an indication of a configuration for determining the quantity of bits based at least in part on the uncertainty value, the configuration indicating a mapping between one or more ranges of uncertainty values and respective quantities of bits.
Aspect 9: The method of aspect 8, wherein receiving the indication of the configuration further comprises: receiving, from the network entity, a channel state information report configuration comprising the indication, a medium access control control element that activates a channel state information report comprising the indication, or downlink control information that activates the channel state information report comprising the indication wherein the channel state information report comprises the bits of the encoded sequences of predicted values.
Aspect 10: The method of any of aspects 1 through 9, further comprising: transmitting, to the network entity, an indication of the quantity of bits of the at least the subset of encoded sequences of predicted values.
Aspect 11: The method of aspect 10, wherein transmitting the indication of the quantity of bits corresponds to a mathematical model of a plurality of mathematical models for predicting the sequence of values for the at least one parameter.
Aspect 12: The method of any of aspects 1 through 11, further comprising: transmitting, to the network entity, a channel state information report comprising a first portion and a second portion, the first portion comprising an indication of the quantity of bits and the second portion comprising the bits of the at least the subset of encoded sequences of predicted values.
Aspect 13: The method of any of aspects 1 through 12, wherein the at least one parameter comprises one or more reference signal received powers, one or more signal-to-interference-plus-noise ratios, or both.
Aspect 14: The method of any of aspects 1 through 13, wherein transmitting the message to the network entity further comprises: transmitting a channel state information report or a medium access control control element to the network entity, wherein the channel state information report or the medium access control control element comprises the bits of the encoded sequences of predicted values.
Aspect 15: The method of any of aspects 1 through 14, wherein each beam of the plurality of beams corresponds to a respective beam-pair of a plurality of beam-pairs for communications between the UE and the network entity.
Aspect 16: A method for wireless communication at a network entity, comprising: transmitting a plurality of reference signals via a first plurality of beams; receiving, from a UE, a message comprising a set of bits based at least in part on transmitting the plurality of reference signals, wherein a total quantity of bits in the set of bits is based at least in part on an uncertainty value associated with sequences of predicted values for at least one parameter, the sequences of predicted values associated with a second plurality of beams; and performing one or more decoding operations on the set of bits based at least in part on the uncertainty value, wherein the network entity identifies the sequences of predicted values based at least in part on performing the one or more decoding operations.
Aspect 17: The method of aspect 16, further comprising: transmitting, to the UE, an indication of a configuration for determining the uncertainty value for the sequences of predicted values.
Aspect 18: The method of any of aspects 16 through 17, wherein performing the one or more decoding operations further comprises: performing the one or more decoding operations based at least in part on a configuration for determining the uncertainty value based at least in part on the total quantity of bits in the set of bits.
Aspect 19: The method of any of aspects 16 through 18, further comprising: determining the uncertainty value associated with the sequences of predicted values based at least in part on the total quantity of bits in the set of bits.
Aspect 20: The method of any of aspects 16 through 19, further comprising: transmitting a request to the UE to transmit the message based at least in part on a ranking of the sequences of predicted values, wherein the uncertainty value for the sequences of predicted values is based at least in part on an average of a set of uncertainty values for the sequences of predicted values.
Aspect 21: The method of any of aspects 16 through 19, further comprising: transmitting a request to the UE to transmit the message based at least in part on a ranking of the sequences of predicted values, wherein the uncertainty value for the sequences of predicted values is based at least in part on a maximum uncertainty value of a set of uncertainty values for the sequences of predicted values.
Aspect 22: The method of any of aspects 16 through 19, further comprising: transmitting a request to the UE to transmit the message based at least in part on a ranking of the sequences of predicted values, wherein the uncertainty value for the sequences of predicted values is based at least in part on a comparison of respective values of the at least one parameter, each respective value corresponding to a respective sequence of values.
Aspect 23: The method of any of aspects 16 through 22, wherein receiving the message from the UE further comprises: receiving the message comprising the bits, wherein the bits correspond to a quantity of the sequences of predicted values having respective rankings that satisfy a threshold.
Aspect 24: The method of any of aspects 16 through 23, further comprising: receiving, from the UE, an indication of a configuration for determining the uncertainty value.
Aspect 25: The method of aspect 24, wherein the configuration for determining the uncertainty value corresponds to a mathematical model of a plurality of mathematical models for predicting the sequences of values for the at least one parameter.
Aspect 26: The method of any of aspects 16 through 23, further comprising: transmitting, to the UE, an indication of a configuration for determining the total quantity of bits based at least in part on the uncertainty value, the configuration indicating a mapping between one or more ranges of uncertainty values and respective total quantities of bits.
Aspect 27: The method of aspect 26, wherein transmitting the indication of the configuration further comprises: transmitting, to the UE, a channel state information report configuration comprising the indication, a medium access control control element that activates a channel state information report comprising the indication, or downlink control information that activates the channel state information report comprising the indication, wherein the channel state information report comprises the set of bits.
Aspect 28: The method of any of aspects 16 through 27, wherein each beam of the first plurality of beams corresponds to a respective beam-pair of a first plurality of beam-pairs for communications between the network entity and the UE; and each beam of the second plurality of beams corresponds to a respective beam-pair of a second plurality of beam-pairs for the communications between the network entity and the UE.
Aspect 29: An apparatus for wireless communication at a UE, comprising a processor; memory coupled with the processor; and instructions stored in the memory and executable by the processor to cause the apparatus to perform a method of any of aspects 1 through 15.
Aspect 30: An apparatus for wireless communication at a UE, comprising at least one means for performing a method of any of aspects 1 through 15.
Aspect 31: A non-transitory computer-readable medium storing code for wireless communication at a UE, the code comprising instructions executable by a processor to perform a method of any of aspects 1 through 15.
Aspect 32: An apparatus for wireless communication at a network entity, comprising a processor; memory coupled with the processor; and instructions stored in the memory and executable by the processor to cause the apparatus to perform a method of any of aspects 16 through 28.
Aspect 33: An apparatus for wireless communication at a network entity, comprising at least one means for performing a method of any of aspects 16 through 28.
Aspect 34: A non-transitory computer-readable medium storing code for wireless communication at a network entity, the code comprising instructions executable by a processor to perform a method of any of aspects 16 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a user equipment (UE), comprising:
predicting, for each of a plurality of beams, a sequence of values for at least one parameter;
performing respective encoding operations on at least a subset of the sequences of predicted values for the at least one parameter for at least a subset of the plurality of beams, wherein a quantity of bits of the encoded sequences of predicted values generated by performing the respective encoding operations is based at least in part on an uncertainty value for the sequences of predicted values; and
transmitting, to a network entity, a message comprising the bits of the encoded sequences of predicted values.

2. The method of claim 1, further comprising:
receiving a request from the network entity to transmit the message based at least in part on a ranking of the sequences of predicted values, wherein the UE determines the uncertainty value for the at least the subset of the sequences of predicted values based at least in part on a function of respective variance values of the at least the subset of the sequences of predicted values.

3. The method of claim 1, further comprising:
receiving a request from the network entity to transmit the message based at least in part on a ranking of the sequences of predicted values, wherein the UE determines the uncertainty value for the at least the subset of the sequences of predicted values based at least in part on a variance value of a sequence of predicted values of the subset of the sequences of predicted values, the sequence of predicted values selected from the subset of the sequences of predicted values based at least in part on respective signal powers associated with the subset of the sequences of predicted values.

4. The method of claim 1, wherein transmitting the message to the network entity further comprises:
transmitting the message comprising the bits of the at least the subset of encoded sequences of predicted values, wherein the bits correspond to a quantity of the at least the subset of the sequences of predicted values having respective rankings that satisfy a threshold.

5. The method of claim 1, further comprising:
receiving, from the network entity, an indication of a configuration for determining the uncertainty value for the at least the subset of the sequences of predicted values, where the UE determines the uncertainty value based at least in part on the configuration.

6. The method of claim 1, further comprising:
determining the uncertainty value for the at least the subset of the sequences of predicted values; and
transmitting, to the network entity, an indication of a configuration for determining the uncertainty value.

7. (canceled)

8. The method of claim 1, further comprising:
receiving, from the network entity, an indication of a configuration for determining the quantity of bits based at least in part on the uncertainty value, the configuration indicating a mapping between one or more ranges of uncertainty values and respective quantities of bits.

9. (canceled)

10. The method of claim 1, further comprising:
transmitting, to the network entity, an indication of the quantity of bits of the at least the subset of encoded sequences of predicted values.

11. (canceled)

12. The method of claim 1, further comprising:
transmitting, to the network entity, a channel state information report comprising a first portion and a second portion, the first portion comprising an indication of the quantity of bits and the second portion comprising the bits of the at least the subset of encoded sequences of predicted values.

13. The method of claim 1, wherein the at least one parameter comprises one or more reference signal received powers, one or more signal-to-interference-plus-noise ratios, or both.

14. The method of claim 1, wherein transmitting the message to the network entity further comprises:
transmitting a channel state information report or a medium access control control element to the network entity, wherein the channel state information report or the medium access control control element comprises the bits of the encoded sequences of predicted values.

15. The method of claim 1, wherein each beam of the plurality of beams corresponds to a respective beam-pair of a plurality of beam-pairs for communications between the UE and the network entity.

16. A method for wireless communication at a network entity, comprising:
transmitting a plurality of reference signals via a first plurality of beams;
receiving, from a user equipment (UE), a message comprising a set of bits based at least in part on transmitting the plurality of reference signals, wherein a total quantity of bits in the set of bits is based at least in part on an uncertainty value associated with sequences of predicted values for at least one parameter, the sequences of predicted values associated with a second plurality of beams; and
performing one or more decoding operations on the set of bits based at least in part on the uncertainty value, wherein the network entity identifies the sequences of predicted values based at least in part on performing the one or more decoding operations.

17. The method of claim 16, further comprising:
transmitting, to the UE, an indication of a configuration for determining the uncertainty value for the sequences of predicted values.

18. The method of claim 16, wherein performing the one or more decoding operations further comprises:
performing the one or more decoding operations based at least in part on a configuration for determining the uncertainty value based at least in part on the total quantity of bits in the set of bits.

19. The method of claim 16, further comprising:
determining the uncertainty value associated with the sequences of predicted values based at least in part on the total quantity of bits in the set of bits.

20. The method of claim 16, further comprising:
transmitting a request to the UE to transmit the message based at least in part on a ranking of the sequences of predicted values, wherein the uncertainty value for the sequences of predicted values is based at least in part on an average of a set of uncertainty values for the sequences of predicted values.

21. The method of claim 16, further comprising:
transmitting a request to the UE to transmit the message based at least in part on a ranking of the sequences of predicted values, wherein the uncertainty value for the sequences of predicted values is based at least in part on a maximum uncertainty value of a set of uncertainty values for the sequences of predicted values.

22. The method of claim 16, further comprising:
transmitting a request to the UE to transmit the message based at least in part on a ranking of the sequences of predicted values, wherein the uncertainty value for the sequences of predicted values is based at least in part on a comparison of respective values of the at least one parameter, each respective value corresponding to a respective sequence of values.

23-28. (canceled)

29. An apparatus for wireless communication at a user equipment (UE), comprising:
a processor,
memory coupled with the processor; and
instructions stored in the memory and executable by the processor to cause the apparatus to:
predict, for each of a plurality of beams, a sequence of values for at least one parameter;
perform respective encoding operations on at least a subset of the sequences of predicted values for the at least one parameter for at least a subset of the plurality of beams, wherein a quantity of bits of the encoded sequences of predicted values generated by performing the respective encoding operations is based at least in part on an uncertainty value for the sequences of predicted values; and
transmit, to a network entity, a message comprising the bits of the encoded sequences of predicted values.

30. (canceled)
